(19) United States
(12) Patent Application Publication
(10) Pub. No.: US 2018/0362190 A1
(43) Pub. Date: Dec. 20, 2018

(54) Autonomous Aircraft Health Systems and Methods

(71) Applicant: Aurora Flight Sciences Corporation, Manassas, VA (US)

(72) Inventors: Jeffrey T. Chambers, Manassas, VA (US); Nikola D. Baltadjiev, Manassas, VA (US)

(21) Appl. No.: 16/008,327

(22) Filed: Jun. 14, 2018

Related U.S. Application Data
(60) Provisional application No. 62/519,989, filed on Jun. 15, 2017.

(51) Int. Cl. B64F 5/60; G07C 5/08

(52) U.S. Cl. CPC B64F 5/60; B64D 2045/0085; B64C 2201/141; G07C 5/0866

(57) ABSTRACT

The present disclosure relates to aircraft and aircraft flight control systems, methods, and apparatuses. A condition-aware aircraft configured to make in-flight decisions autonomously, based on the most up-to-date information, to perform missions under dynamic conditions, while also providing in situ feedback to maintenance units and depots in order to coordinate required and upcoming maintenance.

### CROSS-REFERENCE TO RELATED APPLICATION

The present application claims the benefit under 35 U.S.C. § 119(e) of U.S. Provisional Patent Application Ser. No. 62/519,989, filed Jun. 15, 2017 and titled “Autonomous Aircraft Health Systems and Methods,” the contents of which are hereby incorporated by reference.

### STATEMENT OF GOVERNMENT INTEREST

This invention was made with government support under Contract Number: FA8501-15-C-0026 awarded by the U.S. Air Force's Small Business Innovation Research (SBIR) Program. The government has certain rights in the invention.

### TECHNICAL FIELD

The present disclosure relates to the field of aircraft and aircraft flight control systems, methods, and apparatuses.

### BACKGROUND

Many organisms, including humans, employ feedback to adjust their behavior based on, for example, pain, energy levels, environment, etc. For example, a runner on a hot day will slow down to avoid over-exertion and fatigue. A human with a sore knee will shift weight onto the other leg to reduce stress in the knee until it heals. A hiker will seek an alternate route if an unexpected obstacle has closed a trail.

It similarly advantageous to provide a condition-aware aircraft capable of responding intelligently using sensors to gather information about itself and its surroundings. For example, an aircraft may be configured to continuously respond to real-time events and degradation. Therefore, a need exists for an aircraft capable of sensing system anomalies, thereby allowing the aircraft to operate at its maximum potential and to autonomously rely more heavily on healthy systems to safely complete missions upon detection of an anomaly.

### SUMMARY OF THE INVENTION

The present disclosure is directed to aircraft and aircraft flight control systems, methods, and apparatuses; more specifically, to a condition-aware aircraft configured to make in-flight decisions autonomously, based on the most up-to-date information, to perform missions under dynamic conditions, while also providing in situ feedback to maintenance units and depots in order to coordinate required and upcoming maintenance.

According to a first aspect, a health monitoring system for an aircraft having a flight control system, a primary structure, and a propulsion system, the monitoring system comprising: a plurality of sensors configured to monitor dynamically one or more parameters of the primary structure and the propulsion system; and a processor operatively coupled with the flight control system, the plurality of sensors, and a memory device, wherein the processor is configured to: generate, via the processor, a structural model of the primary structure based at least in part on the one or more parameters, wherein the structural model reflects a dynamic structural integrity of the primary structure; generate, via the processor, a propulsor model of the propulsion system based at least in part on the one or more parameters, wherein the propulsor model reflects a dynamic performance condition of the propulsion system; compute flight path and maneuver capabilities for the self-aware aircraft based at least in part on the dynamic structural integrity of the primary structure and the dynamic performance condition of the propulsion system; generate flight commands based at least in part on the flight path and maneuver capabilities; and communicate the flight commands to the flight control system.

In certain aspects, the plurality of sensors are configured to measure at least a thermodynamic parameter of the propulsion system and a mechanical parameter of the primary structure.

In certain aspects, the plurality of sensors comprises at least one of a strain sensor or an electrical resistance sensor embedded in the primary structure.

In certain aspects, the plurality of sensors comprises at least one of a temperature sensor or a pressure sensor integrated with the propulsion system.

In certain aspects, at least one of the plurality of sensors is configured to communicate wirelessly with the processor via a wireless transmitter or a wireless transceiver.

In certain aspects, the processor is configured to generate updated flight commands dynamically in response to structural changes detected within the primary structure by one or more of the plurality of sensors.

In certain aspects, the processor is configured to compare a calculated performance for a propulsion system component to available sensor signals in order to estimate the health state of the propulsion system component.

In certain aspects, the processor is configured, via the propulsor model, to estimate a health state or a remaining useful life of the propulsion system based at least in part on an extended Kalman filter (EKF) theory.

According to a second aspect, a self-aware aircraft comprising: a primary structure; a propulsion system; a flight control system; a plurality of sensors configured to monitor dynamically one or more parameters of the primary structure and the propulsion system; a processor operatively coupled with the flight control system, the plurality of sensors, and a memory device; a structures subsystem module configured to generate a structural model of the primary structure based at least in part on the one or more parameters, wherein the structural model reflects a dynamic structural integrity of the primary structure; a propulsion subsystem module configured to generate a propulsor model of the propulsion system based at least in part on the one or more parameters, wherein the propulsor model reflects a dynamic performance condition of the propulsion system; and a motion planner module configured to generate, via the processor, flight commands during operation of the self-aware aircraft based at least in part on the dynamic structural integrity and the dynamic performance condition.

In certain aspects, the primary structure comprises a composite material and the at least one of the plurality of sensors is embedded in the composite material.

In certain aspects, the plurality of sensors comprises at least one of a strain sensor or an electrical resistance sensor embedded in the primary structure.

In certain aspects, the plurality of sensors comprises at least one of a temperature sensor or a pressure sensor integrated with the propulsion system.

In certain aspects, the structures subsystem module, propulsion subsystem module, and motion planner module are communicatively coupled to one another and to the flight control system via a data bus.

In certain aspects, the data bus is a Data Distribution Service (DDS) open standard data bus.

In certain aspects, the data bus is operatively coupled with the plurality of sensors via one or more abstraction layers.

In certain aspects, at least one of the plurality of sensors is configured to monitor a surrounding environment of the self-aware aircraft and the motion planner module generated the flight commands to account for surrounding environment.

In certain aspects, the processor is configured to provide in situ feedback to a remotely situated maintenance unit to coordinate maintenance of the self-aware aircraft.

According to a third aspect, a method of navigating a self-aware aircraft having a flight control system, a primary structure, and a propulsion system, the method comprising the steps of: monitoring via one or more sensors operatively coupled with a processor, one or more parameters of the primary structure and the propulsion system during operation; generating, via the processor, a structural model of the primary structure based at least in part on the one or more parameters, wherein the structural model reflects a dynamic structural integrity of the primary structure; generating, via the processor, a propulsor model of the propulsion system based at least in part on the one or more parameters, wherein the propulsor model reflects a dynamic performance condition of the propulsion system; computing flight path and maneuver capabilities for the self-aware aircraft based at least in part on the dynamic structural integrity of the primary structure and the dynamic performance condition of the propulsion system; generating flight commands based at least in part on the flight path and maneuver capabilities; and communicating the flight commands to the flight control system.

In certain aspects, the method further comprises the step of monitoring a surrounding environment of the self-aware aircraft, wherein the flight commands account for surrounding environment.

In certain aspects, the method further comprises the step of providing in situ feedback to a remotely situated maintenance unit to coordinate maintenance of the self-aware aircraft.

In certain aspects, the flight control commands comprise at least a pitch command and a flight speed command.

### DRAWINGS

These and other advantages of the present disclosure may be readily understood with the reference to the following specifications and attached drawings wherein:

FIG. 1a illustrates an example fixed-wing condition-aware aircraft.

FIG. 1b illustrates a block diagram of an example aircraft control system to facilitate an autonomous aircraft health system in a condition-aware aircraft.

FIG. 2 illustrates a chart of an aircraft's residual strength as a function of time to illustrate the benefits of condition-aware flight.

FIG. 3 illustrates example architecture for an autonomous aircraft health system.

FIG. 4 illustrates an example abstraction approach using a Robot Operating System (ROS) to transition to Data Distribution Service (DDS) transport layer.

FIG. 5 illustrates fuel consumption savings of an aircraft with a degraded engine using the autonomous aircraft health system.

FIG. 6 illustrates an inlet turbine temperature of degraded engine.

FIG. 7 illustrates an engine model schematic of a turbofan engine.

FIG. 8 illustrates a schematic of the propulsion health state estimator of the propulsion PHM module.

FIG. 9 illustrates example engine state measurements.

FIG. 10 illustrates example degradation estimations for a turbo fan engine.

FIG. 11 illustrates a graph of prognoses based on current aircraft condition vis-à-vis a nominally expected prognosis.

FIGS. 12a through 12c illustrate subsystems of the structures subsystem module that facilitate design and safety-assured maneuvering.

FIG. 13 illustrate an example schematic of the system architecture for the motion planner module.

FIG. 14 illustrates an example method for providing adjustments to flight maneuvers.

FIG. 15 illustrates an example implementation of the autonomous aircraft health system framework.

### DESCRIPTION

Preferred embodiments of the present disclosure may be described hereinbelow with reference to the accompanying drawings. In the following description, well-known functions or constructions are not described in detail because they may obscure the disclosure in unnecessary detail. For this disclosure, the following terms and definitions shall apply.

As utilized herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first set of one or more lines of code and may comprise a second “circuit” when executing a second set of one or more lines of code.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the term “exemplary” means serving as a non-limiting example, instance, or illustration, while the terms “e.g.,” and “for example” set off lists of one or more non-limiting examples, instances, or illustrations.

As used herein, the words “about” and “approximately,” when used to modify or describe a value (or range of values), mean reasonably close to that value or range of values. Thus, the embodiments described herein are not limited to only the recited values and ranges of values, but rather should include reasonably workable deviations.

As utilized herein, circuitry or a device is “operable” to perform a function whenever the circuitry or device comprises the necessary hardware and code (if any is necessary) to perform the function, regardless of whether performance of the function is disabled, or not enabled (e.g., by a user-configurable setting, factory trim, etc.).

As used herein, the terms “aerial vehicle” and “aircraft” refer to a machine capable of flight (e.g., air planes, spacecraft, etc.), including, but not limited to, both traditional runway and vertical takeoff and landing (“VTOL”) aircraft, and also including both manned and unmanned aerial vehicles (“UAV”). VTOL aircraft may include fixed-wing aircraft (e.g., Harrier jets), rotorcraft (e.g., helicopters, multi-rotor aircraft, etc.), and/or tilt-rotor/tilt-wing aircraft.

As used herein, the terms “communicate” and “communicating” refer to (1) transmitting, or otherwise conveying, data from a source to a destination, and/or (2) delivering data to a communications medium, system, channel, network, device, wire, cable, fiber, circuit, and/or link to be conveyed to a destination.

The term “composite material” as used herein, refers to a material comprising an additive material and a matrix material. For example, a composite material may comprise a fibrous additive material (e.g., fiberglass, glass fiber (“GF”), carbon fiber (“CF”), aramid/para aramid synthetic fibers, etc.) and a matrix material (e.g., epoxies, polyimides, and alumina, including, without limitation, thermoplastic, polyester resin, polycarbonate thermoplastic, casting resin, polymer resin, acrylic, chemical resin). In certain aspects, the composite material may employ a metal, such as aluminum and titanium, to produce fiber metal laminate (FML) and glass laminate aluminum reinforced epoxy (GLARE). Further, composite materials may include hybrid composite materials, which are achieved via the addition of some complementary materials (e.g., two or more fiber materials) to the basic fiber/epoxy matrix.

As used herein, the term “database” means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list, or data presented in any other form.

As used herein, the term “processor” means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC). The processor may be coupled to, or integrated with a memory device.

As used herein, the term “memory device” means computer hardware or circuitry to store information for use by a processor. The memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like.

The capability of an aircraft changes over its lifetime, therefore a variety of different tools may be used to observe the capability of different aspects of the aircraft throughout its useful lifespan. To that end, disclosed herein is an autonomous aircraft health system that provides an ability to dynamically (e.g., continuously, in real-time or near real-time) sense aircraft anomalies, which enables the aircraft to autonomously adjust its operation. For example, relying more heavily on remaining healthy systems to complete a mission safely. The autonomous aircraft health system provides architecture for different prognostics and health management (PHM) systems to communicate with each other and the aircraft to generate a complete picture of the health for the aircraft, thereby enabling the aircraft to operate at its maximum current capability.

Unlike existing PHM systems, which cannot connect different subsystems to generate information that is relevant to the other systems, the autonomous aircraft health system employs various PHM sensors throughout the aircraft to realize a condition-aware vehicle that can fly to its current capability (e.g., based on its current state-of-health). Indeed, existing PHM systems, on the contrary, rely on multiple disconnected subsystems. For example, in existing PHM systems, a mission planner would not be able to consider the health of the spar in the wing (or the fuel efficiency of the engine) as a function of the degradation state of different portions of the turbo machinery. In addition to diagnosing health state issues of the aircraft, the autonomous health system also enables the condition-aware aircraft to adapt during a mission (i.e., mid-mission) to changes in the aircraft and aircraft subsystems. Accordingly, the condition-aware aircraft can operate up to its current limits, while maintaining system safety. The autonomous health system further incorporates multi-disciplinary, physics-based models, and PHM sensor suites to fully functionalize the flight environment of an aircraft with respect to its structural and propulsion capabilities, which allows for optimization of mission execution as well as condition based maintenance.

A condition-aware aircraft, however, can autonomously make in-flight decisions to perform missions under dynamic conditions while also providing in situ feedback to maintenance units and depots in order to coordinate required and upcoming maintenance. The in-flight decisions may be based on, inter alia, the most up-to-date information regarding the aircraft's state-of-health. Benefits of the autonomous aircraft health system are discussed below, which illustrate the capability of the autonomous aircraft health system to react to unanticipated degradation events.

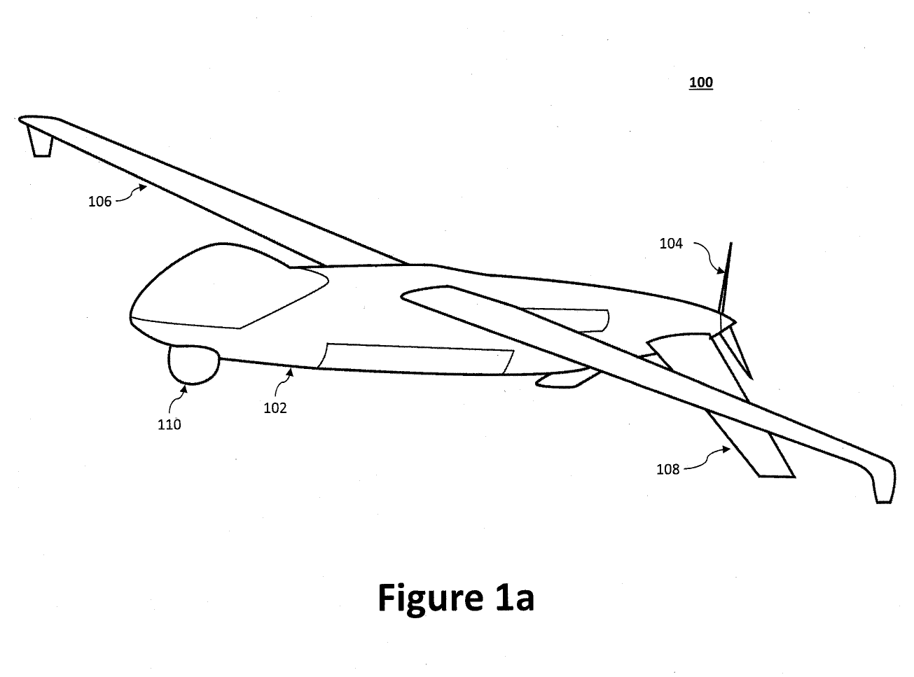

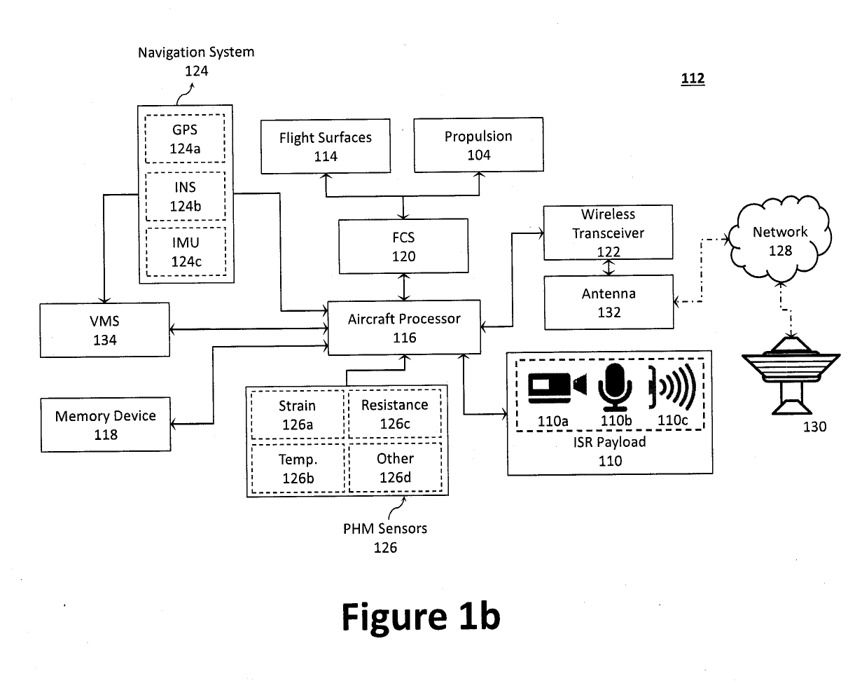

FIG. 1a illustrates a perspective view of an example condition-aware aircraft 100 having an autonomous aircraft health system 300. The condition-aware aircraft 100 may be a fixed-wing aircraft having a fuselage 102, one or more propulsors 104, one or more wing panels 106 (or other lifting surfaces), and/or an empennage 108 (or other stabilizing or control surfaces). While FIG. 1a illustrates fixed-wing condition-aware aircraft 100, the subject disclose is not limited to a particular aircraft configuration, but rather, may be a VTOL aircraft, a helicopter, a multi-rotor aircraft, etc.

The condition-aware aircraft's 100 airframe and body panels may be fabricated using materials that are lightweight, with a high specific strength, heat resistant, fatigue load resistant, crack resistant, and/or corrosion resistant. Suitable materials include, for example, composite materials and metals (e.g., aluminum, steel, titanium, and metal alloys). The size and purpose of the condition-aware aircraft 100 may determine the type of materials used. For instance, smaller to midsize aircraft may be more easily fabricated from only composite materials, while larger aircraft may warrant metal. For example, portions of the airframe may be a metal, while the body panels may be fabricated from composite material and/or metal. Metal fittings may be further used to couple or join the various components of the condition-aware aircraft 100, whether metal or composite material. While the condition-aware aircraft 100 is illustrated as having a fuselage 102 that is distinct from the one or more wing panels 106, other configurations are contemplated, such as flying wing aircraft.

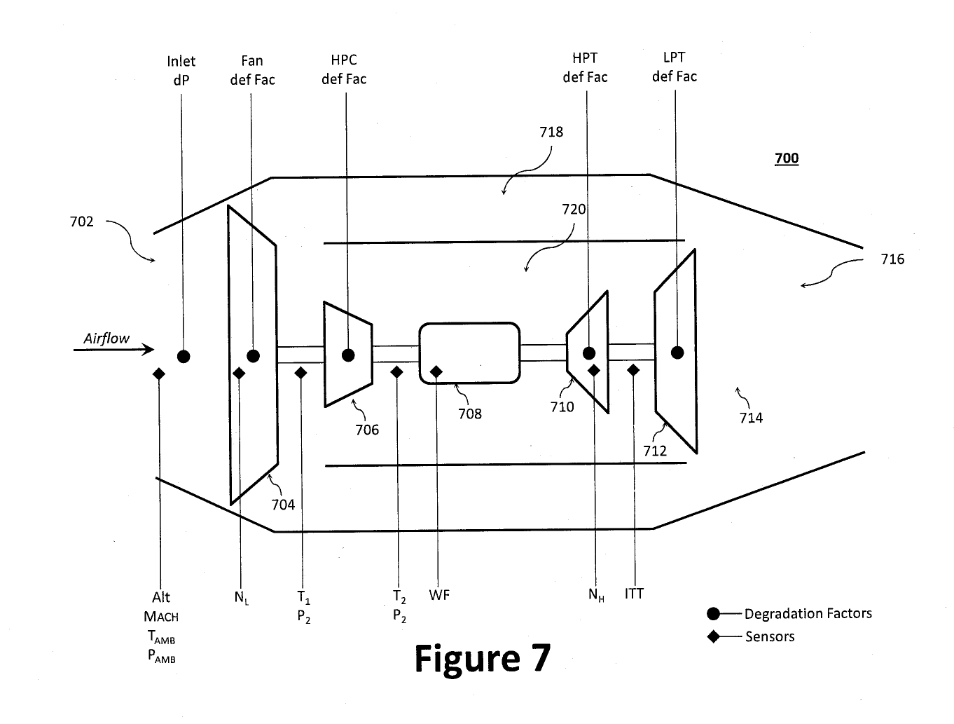

The one or more propulsors 104 may employ, for example, jet propulsion (e.g., a jet engine, turbofan engine, etc.) or propeller-driven (e.g., one or more propellers axially driven by an engine or electric motor). A suitable turbofan engine 700 is illustrated in FIG. 7. While the condition-aware aircraft 100 is illustrated as having a single propulsor 104, it should be appreciated additional propulsors 104 may be provided. For example, one or more propulsors 104 may be provided on each side of the wing panels 106.

In a propeller-driven embodiment, the propeller may be driven by an engine or electric motor either directly or indirectly through a transmission and associated gearing. The one or more engines or electric motors may be positioned, for example, within the fuselage 102, on the wing panels 106, or elsewhere on the condition-aware aircraft 100. In certain aspects, a single electric motor may be configured to drive plural propellers through a transmission or other gearing configuration; however, a dedicated electric motor may be provided for each propeller if desired. The propulsors 104 may be attached to the wing panel 106 (e.g., at a rib), a fuselage 102, etc. Where electric motors are used, the motors may be direct current (“DC”) brushless motors, but other motor types may be used to meet a particular need.

The one or more propulsors 104 may be configured in a pusher configuration (as illustrated) or, a tractor configuration. In a tractor configuration, the propulsors 104 are situated forward (at the front) of the fuselage 102. During operation, the one or more propulsors 104 may be throttled (e.g., under control of the pilot or flight control system) to produce a desired thrust force acting along the axis of the propulsor.

The empennage 108 may include a first tail panel and a second tail panel, which may be arranged as an inverted V configuration (i.e., “∧” configuration). The angle between the first tail panel and the second tail panel, however, may be adjusted. Therefore, other configurations are contemplated, including a “T-”, “Pi-”/“π-”, “X-”, “V-”, and “∧-” arrangements. In certain aspects, one or more of the tail panels may be all moving and/or fuselage- or wing-mounted. Indeed, the empennage 108 and the wing panel 106 may be fitted with traditional aerodynamic trailing edge control surfaces, such as ailerons, camber changing flaps, etc. One of skill in the art in view of the subject disclosure, however, would appreciate that other configurations are possible. For example, the empennage 108 may be omitted in favor of forward mounted control and stabilizing surfaces (e.g., a canard). The condition-aware aircraft 100 may include an intelligence, surveillance, and reconnaissance (“ISR”) payload 110, which may be used to collect data and/or monitor an area. The ISR payload 110 may be rotatably and pivotally coupled to, for example, the underside surface of the fuselage 102 (or another structural component, such as the wing panels 106) via a gimbal system to enable the ISR payload 110 to be more easily oriented to monitor objects below and/or on the ground.

FIG. 1b illustrates a block diagram of an example aircraft control system 112 to facilitate an autonomous aircraft health system 300 in the condition-aware aircraft 100 having an autonomous aircraft health system 300. Unlike prior PHM efforts, many of the sensors (e.g., ISR payload 110 and PHM sensors 126) and processors (e.g., aircraft processor 116) are traditionally onboard existing aircraft, thereby mitigating the need for additional hardware to implement the autonomous aircraft health system 300. Additional computing and networking hardware may be provided on the ground station (e.g., remote computer 130), however, to provide the model-based prognostics and coordination with a logistics infrastructure.

The aircraft control system 112 is operable to control the various aircraft components and functions of the condition-aware aircraft 100, which can dynamically adapt the way in which it performs a given mission by gathering information about itself and its surroundings (e.g., via an array of PHM sensors 126 and the ISR payload 110) and responding intelligently (e.g., via the autonomous aircraft health system 300). Indeed, condition-awareness enables an aircraft to react intelligently to in situ changes to on-board subsystems and dynamic changes to the surrounding environment. In addition, condition-awareness also permits the condition-aware aircraft 100 to fly at its current maximum capability—even if the current capability dictates a reduction of its normal operation.

As illustrated, the condition-aware aircraft 100 includes one or more aircraft processors 116 communicatively coupled with at least one memory device 118, a flight control system 120, a wireless transceiver 122, and a navigation system 124. The aircraft processor 116 may be configured to perform one or more operations based at least in part on instructions (e.g., software) and one or more databases stored to the memory device 118 (e.g., hard drive, flash memory, or the like).

The aircraft control system 112 may include a wireless transceiver 122 coupled with an antenna 132 to communicate data between the condition-aware aircraft 100 and a remote computer 130 (e.g., an air traffic controller, base station, or even portable electronic devices, such as smartphones, tablets, and laptop computers) and/or with subsystems of the condition-aware aircraft 100. The condition-aware aircraft 100 may communicate data (processed data, unprocessed data, etc.) with the remote computer 130 over a network 128. For example, in certain aspects, unprocessed data from the various onboard sensors (e.g., the PHM sensors 126, the ISR payload 110, etc.) may be communicated from the condition-aware aircraft 100 via the wireless transceiver 122 as raw data for remote processing. For example, the condition-aware aircraft 100 may dynamically communicate the unprocessed data to the remote device 130 via the wireless transceiver 122, whereby the remote device 130 may be configured to perform the model-based prognostics. An advantage of remote data processing is that processing resources needed onboard the condition-aware aircraft 100 may be reduced, thereby reducing weight, power consumption, and cost of the condition-aware aircraft 100. In certain aspects, the wireless transceiver 122 may be configured to communicate using one or more wireless standards such as Bluetooth (e.g., short-wavelength, Ultra-High Frequency (UHF) radio waves in the Industrial, Scientific, and Medical (ISM) band from 2.4 to 2.485 GHz), near-field communication (NFC), Wi-Fi (e.g., Institute of Electrical and Electronics Engineers' (IEEE) 802.11 standards), etc. The remote computer 130 may facilitate monitoring and/or control of the condition-aware aircraft 100 and its payload(s), including the ISR payload 110.

The aircraft processor 116 may be operatively coupled to the flight control system (FCS) 120 to control operation of the various actuators (e.g., those to control movement of any flight control surfaces 114) and/or propulsor 104 in response to commands from the autonomous aircraft health system 300, an operator, autopilot, a navigation system 124, or other system (e.g., via the wireless transceiver 122). In certain aspects, the aircraft processor 116 and the flight control system 120 may be integrated into a single component or circuitry. In operation, the flight control system 120 may dynamically and independently adjust the flight control surfaces 114 and the thrust from each of the propulsors 104 during the various stages of flight (e.g., take-off, cruising, landing) to control speed, roll, pitch, or yaw of the condition-aware aircraft 100.

The aircraft processor 116 may be operatively coupled to the navigation system 124, which may include a global positioning system (GPS) 124a that is communicatively coupled with an Inertial Navigation System (INS) 124b and/or an inertial measurement unit (IMU) 124c, which can include one or more gyroscopes and accelerometers. The GPS 124a gives an absolute drift-free position value that can be used to reset the INS solution or can be blended with it by use of a mathematical algorithm, such as a Kalman Filter. The navigation system 124 may communicate, inter alia, inertial stabilization data to the aircraft processor 116.

The aircraft processor 116 may be operatively coupled to a vehicle management system (VMS) 134, which may include one or more sensors to generate (or collect) operating condition information about the aircraft, such as position, velocity, ambient, and other flight conditions. To that end, the VMS 134 may be operatively coupled with the navigation system 124, either directly or via the aircraft processor 116. In certain aspects, the VMS 134 may be integral with the flight control system 120.

As noted above, the condition-aware aircraft 100 may be further equipped with an ISR payload 110 to collect data and/or monitor an area. The ISR payload 110 may include, for example, one or more cameras 110a (e.g., an optical instrument for recording or capturing images and/or video, including light detection and ranging (LIDAR) devices), audio devices 110b (e.g., microphones, echolocation sensors, etc.), and other sensors 110c (e.g., temperature sensors) to facilitate ISR functionality and to provide ISR data (e.g., photographs, video, audio, sensor measurements, etc.) Any video, or other data, collected by the condition-aware aircraft 100 may be dynamically communicated to a ground control station wirelessly (e.g., a remote computer 130). The condition-aware aircraft 100 may be further equipped to store said video and data to the onboard data memory device 118. The ISR payload 110 is operatively coupled to the aircraft processor 116 to facilitate communication of the ISR data between the ISR payload 110 and the aircraft processor 116. The ISR data may be dynamically or periodically communicated from the condition-aware aircraft 100 to the remote computer 130 over the network 128 via the wireless transceiver 122, or stored to the memory device 118 for later access or processing. In other aspects, the one or more payloads may include hardware that operates as a communication relay or router. For example, the condition-aware aircraft 100 may receive signals from a remotely situated device (e.g., a satellite, communication tower, or even another aircraft) via an onboard antenna 132. The condition-aware aircraft 100 may then relay the information from the remotely situated device to an end user on the ground proximate to the condition-aware aircraft 100. Likewise, to facilitate two-way communication, the condition-aware aircraft 100 may receive information from the end user on the ground and relay it to the remotely situated device.

The aircraft processor 116 may be operatively coupled with an array of PHM sensors 126 distributed throughout the condition-aware aircraft 100. The PHM sensors 126 may include, for example, strain sensors 126a, temperature sensors 126b, electrical resistance sensors 126c, and other sensors 126d (e.g., motion capture sensors, radio-beacons, infrared sensors, acoustic sensors, etc.). The PHM sensors 126 may include in situ sensors embedded throughout the condition-aware aircraft's 100 structure, engines, etc. While wire-connections offer a number of advantages in terms of security and reliability, one or more of the array of PHM sensors 126 may be configured to communicate wirelessly with the aircraft processor 116. To that end, certain of the array of PHM sensors 126 may be provided with transceivers (or a one-way transmitter) to communicate with the wireless transceiver 122 or another transceiver (or a one-way receiver) communicatively coupled to the aircraft processor 116.

The autonomous aircraft health system 300, via one or more processors (e.g., aircraft processor 116), can achieve condition-awareness through architecture of multiple subsystems that communicate with a higher-level system that operates as a reasoning agent. The autonomous aircraft health system 300 dynamically updates its understanding of the surrounding environment as new intelligence and data is available (e.g., via data from the ISR payload 110 and the PHM sensors 126). The ability of the condition-aware aircraft 100 to adapt to changes in internal variables (e.g., subsystems) and external variables (e.g., flight environment) enables the autonomous aircraft health system 300 to tailor or restructure its everyday flight to minimize wear, fatigue, and/or environmental degradation, which adds years to life and reduces maintenance required to maintain airworthiness. The condition-aware aircraft 100 may also autonomously adapt its maneuvers to rely more heavily on healthy systems in order to complete missions. Indeed, the condition-aware aircraft 100 can combine in situ sensors with on-board models to make informed decisions, where reasoning agents determine optimal actions to accomplish mission via in situ adjustments to flight maneuvers. The autonomous aircraft health system 300 may also be used to prioritized maintenance based on fleet capability or requirements, achieve flight optimization based on structure and engine capability, and operate an aircraft 100 at minimal requirements (e.g., a minimal amount of fuel for a particular mission based on the aircraft's state-of-health).

Accordingly, a condition-aware aircraft 100 results in increased vehicle lifetime and reduced maintenance time, while ensuring airworthiness. Indeed, a condition-aware aircraft 100 can operate at its maximum capability, thereby performing missions beyond its traditional design envelope. For example, a condition-aware aircraft 100 can operate at 130% the designed performance and 400% longer without modification to other features of the condition-aware aircraft 100. Indeed, this can be achieved by replacing a traditional damage tolerant design with a dynamic health and capability assessment of the airframe, which extends to the entire condition-aware aircraft 100.

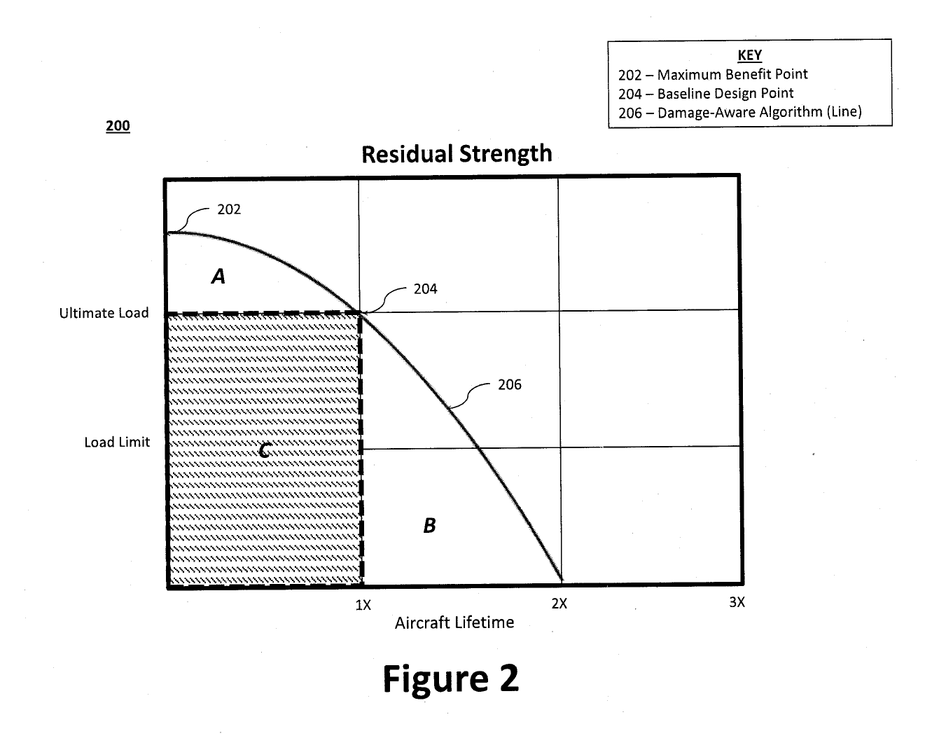

FIG. 2 illustrates a chart 200 of an aircraft's residual strength as a function of time to illustrate the benefits of condition-aware flight. The airframe's residual strength (e.g., an airframe fabricate using composite material) over the condition-aware aircraft's 100 lifetime defines regions of enhanced performance (i.e., region A) and extended life (i.e., region B) beyond the nominal design life, which is indicated by the rectangular shaded region (i.e., region C). More specifically, the maximum benefit point 202 represents the point in time at which the condition-aware aircraft 100 can operate carrying the largest amount of load (e.g., when the condition-aware aircraft 100 is new and therefor its residual strength is maximized), while the baseline design point 204 represents the last point in time at which the condition-aware aircraft 100 can traditionally operate carrying an ultimate load (e.g., an ultimate load dictated by the aircraft manufacturer's specifications). Using the autonomous aircraft health system 300, a damage-aware algorithm may be operated to extend the life of the condition-aware aircraft 100 beyond the baseline design point 204. The extended life of the condition-aware aircraft 100 is represented using the damage-aware algorithm line 206.

Existing in-service prognostics for airframe maintenance concentrate on load measurements, comparing known cyclic loading to rainfall charts and fatigue curves in the case of metallic components, while existing structural health monitoring (SHM) and damage state-awareness ignore loading in favor of direct component monitoring. The autonomous aircraft health system 300, however, considers both the aircraft's state-of-health (e.g., the material health state) and current (and projected) loading to assess more accurately the current (and future) margins of safety based on overall aircraft and mission condition. In addition, the autonomous aircraft health system 300 may also employ multi-model multi-fidelity uncertainty to provide methods to measure individual source uncertainties as they pertain to the global uncertainty. Indeed, the largest sources of uncertainty can be reduced using higher-fidelity models, where the results may be combined to increase the accuracy of the model predictions.

The autonomous aircraft health system 300 benefits from a modular, platform-agnostic sensor suites, and software that can be adapted to various aircraft and missions, thus facilitating the integration of the developed technologies into fielded systems. The autonomous aircraft health system 300 may therefore employ a modular architecture with standard interfaces such as the Data Distribution Service (DDS), the Future Airborne Capability Environment (FACE), and the UAS Control Segment (UCS) standard. The autonomous aircraft health system 300 may employ the standard interfaces to communicate outputs from the autonomous aircraft health system 300, as well as data exchange between system modules, for distribution over a data bus (e.g., a DDS network). The architecture of the autonomous aircraft health system 300 employs hardware and operating system abstraction to facilitate component re-use, services (e.g., plug-n-play), platform-agnostic functionality, and interoperability between system components and other systems. It also allows PHM modules 326 and sensor suites to be easily integrated into the condition-aware aircraft 100.

The autonomous aircraft health system 300 can incorporate multi-disciplinary, physics-based models and sensor suites to fully functionalize the flight environment of a condition-aware aircraft 100 vis-à-vis its structural and propulsion capability, which allows for optimization of condition-aware aircraft 100 use. The autonomous aircraft health system 300, which may be developed around an open architecture to allow future integration of functionalities/modules, offers several synergistic benefits in terms of condition determination, remaining useful life (RUL) prediction, and decision-making. As can be appreciated, an aircraft capable of operating at its maximum current capability calls for knowledge of all subsystems of the aircraft and how each subsystem's capability changes over the life of the aircraft. By incorporating RUL into the current methodology using mission data, it will be possible to optimize operations for extended life (i.e., maximize RUL) and perform trade studies to determine best-use for new condition-aware aircraft 100 that utilize advanced prognostic capabilities for condition-aware flight. The autonomous aircraft health system 300 architecture is modular, allowing vehicle specific plug-ins to be developed in order to expand condition-aware capabilities to multiple aircraft.

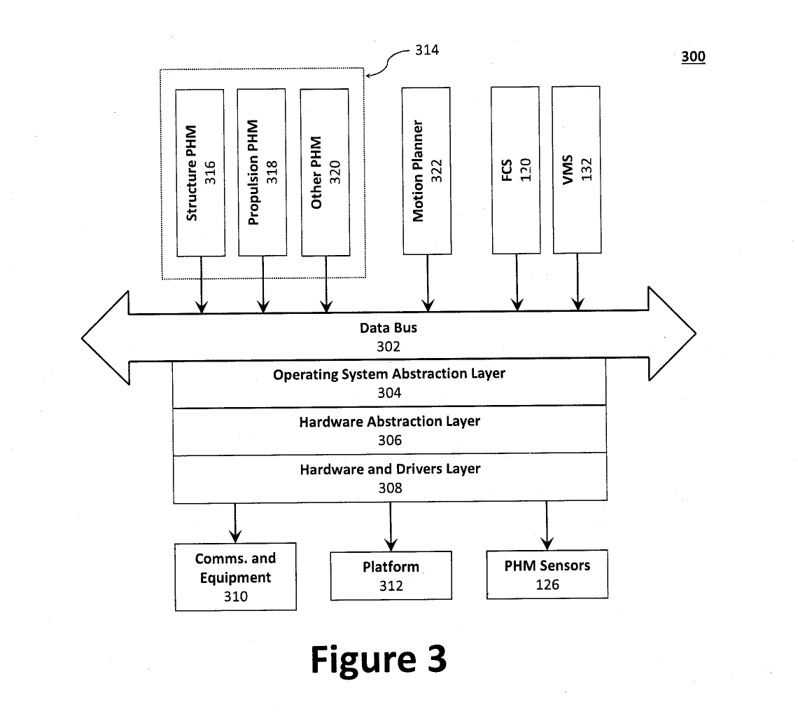

FIG. 3 illustrates example architecture for an autonomous aircraft health system 300. The architecture offers a number of advantages, including: (1) an open architecture layer enables efficient data exchange through publish/subscribe mechanism; (2) platform/mission-specific modules are easily replaced in such architectures; (3) allows for different sensor suites and PHM modules 326 to be integrated into the system; and (4) open architecture facilitates component re-use, enables plug-n-play services. The ability of the condition-aware aircraft 100 to sense-and-feel via the autonomous aircraft health system 300 allows for real-time updates in both the mission execution and the maintenance scheduling.

The architecture of the autonomous aircraft health system 300 is designed such that PHM modules 314 for additional subsystems can be developed and integrated at a later point. Initially, the PHM modules 326 may include, for example, a structures subsystem module 316, a propulsion subsystem module 318, and one or more other subsystem modules 320 to monitor and/or estimate the health of aircraft components (i.e., those other than the airframe and propulsion systems). The autonomous aircraft health system 300 enables integration of vehicle data from various PHM modules 326 with a motion planner module 322 to provide a various functions during flight, including: real-time monitoring; state prediction; and action determination.

Each of the PHM modules 314 and the motion planner module 322 may be communicatively coupled with a data bus 302 (e.g., a Data Distribution Service (DDS) open standard data bus). The data bus 302 may be communicatively coupled with other aircraft systems, such as the flight control system 120 and VMS 134. Information from the flight control system 120 and the VMS 134 regarding the state of the aircraft in terms of position, velocity, ambient and conditions can be distributed to the PHM modules 314 via the data bus 302, along with specific sensor signals required by the respective PHM modules 314 and motion planner module 322 to evaluate subsystem health state. Updated health state performance parameters and RUL estimates, which may be based on the current maximum thrust available and the greatest load factor calculated from the structural model, can be communicated to the motion planner module 322, which adjusts the mission route accordingly and communicates updated waypoints to the flight control system 120.

The autonomous aircraft health system 300 may employ one or more abstraction layers to abstract away the specifics of the data bus 302. For example, the various modules (e.g., the PHM modules 314, motion planner module 322, etc.) may be communicatively coupled with the aircraft hardware via, for example, an operation system abstraction layer 304, a hardware abstraction layer 306, and a hardware/driver layer 308. For example, aircraft hardware may include, for example, communication equipment 310 (e.g., wireless transceiver 122), aircraft platform 312, the PHM sensors 126, etc. The operating system abstraction layer 304 may be used to provide an application-programming interface (API) to an abstract operating system, thereby making it easier and quicker to develop code for multiple software or hardware platforms. The hardware abstraction layer 306 may be used to emulate platform-specific details, thereby obviating the need to develop device-independent, high performance applications by providing standard operating system calls to the aircraft hardware. The hardware/driver layer 308 provides the software necessary, or useful, to operate or control the aircraft hardware.

In operation, the aircraft processor 116, in conjunction with decision-making software stored to the memory device 118, may dynamically receive sensor data from PHM sensors 126 to provide real-time monitoring. The PHM sensors 126 may be located on (or embedded in) the airframe, the propulsion system, and/or the various other subsystems on the condition-aware aircraft 100. The processor 116 performs a self-assessment by dynamically monitoring the real-time sensor data to detect changes or anomalies vis-à-vis information about surrounding environment, which may be received from the ISR payload 110. The processor 116 may also use the real-time sensor data to calculated state prediction using one or more prediction algorithms stored to the memory device 118 that predicts the current state of the various subsystems (e.g., the airframe and propulsion) and updates the avionics with a new vehicle level state. Based at least in part on the state prediction and/or self-assessment, the processor 116 may be employed to facilitate the real-time motion planning and control (e.g., via the motion planner module 322 and the flight control system 120). For example, the processor 116 may make an informed decision about the updated operating envelope of the condition-aware aircraft 100, may provide informative alerts indicating the responsible sub-system(s), and may take autonomous actions to optimize mission performance within the new operating envelope. Information will be updated and communicated to the remote computer 130 to allow for the human-in-the-loop supervisor and maintenance crew to make informed decisions.

Open Architecture. The autonomous aircraft health system 300 is designed to be platform agnostic via its open architecture. For example, the propulsion model can be modified for different aircraft engines or a finite element method (FEM) of primary structures of a new platform can be used. Other modules that could be added to the autonomous aircraft health system 300 include environmental or threat concerns. Indeed, an Open Architecture offers a number of benefits. First, the portability of the open architecture enables the autonomous aircraft health system 300 to retrofit an existing aircraft, which increases the level of autonomy in the existing aircraft, as well as to be implemented in new aircraft designs. Second, the autonomous aircraft health system 300 decreases development time through enabling re-use of existing modules and streamlining the development and integration of new modules. Third, the autonomous aircraft health system 300 enables lower upgrade cost by decreasing the cost and time needed of future upgrades through implementation of scalable, extensible, and interoperable service oriented modules. Finally, the autonomous aircraft health system 300 offers solutions to meet both current and future customer security and operational needs, with faster fielding and lower ownership costs through modular, scalable, portable, extensible, and interoperable system attributes.

The autonomous health system's 300 open architecture, for example, exploits concepts of module partitioning, hardware/software abstraction, loose coupling of functional modules, and a central standardized data exchange layer to create an open, extensible development ecosystem. The approach to creating an open architecture will be openness by necessity—the necessity to create a clear, modular breakdown of system components with openly communicated interfaces. Modular interfaces may be portable across different aircraft such that both legacy and new platforms can exploit the autonomous aircraft health system 300. The modular interfaces may use proprietary or openly available messaging standards. For example, publish-subscribe middleware architecture may be implemented to exchange data to provide interchangeable modules. In a distributed system, middleware is the software layer that resides between the operating system and applications to enable the various components of a system to more easily communicate and exchange data. Middleware simplifies the development of distributed systems by allowing software developers to focus on the specific purpose of their applications rather than the mechanics of passing information between applications and systems. The autonomous health system's 300 middleware handles various types of data flows, including: (1) sensor signals; (2) performance data; (3) health state information; (4) RUL information; (5) mission planer data; and (6) flight control system signals.

The autonomous health system's 300 middleware allows for seamless interaction between multiple networked computers, with transparent integration of modules running on different processors/computer systems and easy migration from one system to another. The modules may be configured to interact with each other over an onboard-wired network where any module onboard the wired network can publish a message and any module on the same wired network can subscribe to it. Though wireless networks are possible, the closed cabling system of an onboard network can be physically secured within the aircraft, which offers a level of security and protection that is more difficult to achieve with wireless networks. In a wired network, messages can be sent unencrypted through TCP/IP or UDP/IP. The default check performed is an initial md5sum of the message structure, a mechanism used to assure the parties agree on the layout of the message.

The autonomous health system's 300 open architecture layer may employ open-source middleware, such as robot operating system (ROS), which may function as a primary communication mechanism to enable a modular and platform-agnostic system that can be adapted to various aircraft. While multiple open-source middleware options exist, the ROS open-source middleware offers certain advantages. First, ROS is implemented using open source software that is documented, with detailed online tutorials. Second, all messages passed by ROS can be queried during operation of the software, so that the behavior of the modular components and their interactions are exposed, including any un-documented messages or sub-modules. Support tools for echoing and logging messages support troubleshooting, which is advantageous in modular systems developed by multiple, different collaborative entities.

The Open Source Robotics Foundation (OSRF), which is the organization that developed and manages ROS, has incorporated Object Management Group's Data Distribution Service (DDS) as a transport layer for ROS 2.0.8. DDS is also a publish-subscribe middleware protocol and API standard for data-centric connectivity, which provides secure communications for dynamic and embedded systems. DDS may be used to configure access, enforce data flow paths, and encrypt data on-the-fly. RTI Connext9 DDS software offers plugins, which comply with the DDS security specifications. The RTI Connext9 DDS software may also configured to (1) provide authentication, authorization, confidentiality, (2) protect discovery information, metadata and data, (3) defend against unauthorized access, tampering, and replay, (4) integrate with existing security infrastructures and hardware acceleration, and (5) secure unmodified existing DDS applications. The Connext Security Capabilities are summarized in Table 1.

TABLE 1

| | |
|---|---|
| Authentication | X.509 Public Key Infrastructure (PKI) with a |
| | pre-configured shared Certificate Authority (CA) |
| | Digital Signature Algorithm (DSA) with |
| | Diffie-Hellman and RSA for authentication |
| | and key exchange |
| Access Control | Specifications via permissions file signed |
| | by shared CA |
| | Control over ability to join DDS Domains |
| | and Partitions, read or write Topics |
| | Control on individual objects and Quality |
| | of Service (QoS) via plugins |
| Cryptography | Protected key distribution |
| | AES128 and AES256 for encryption |
| | HMAC-SHA1 and HMAC-5HA256 for |
| | message authentication and integrity |
| Data Tagging | Used to specify security metadata, |
| | such as classification level |
| | Sent during endpoint discovery |
| | Can be used to determine access |
| | privileges (via plugin) |
| Logging | Log security events to a local file or |
| | distribute securely over Connext DDS |

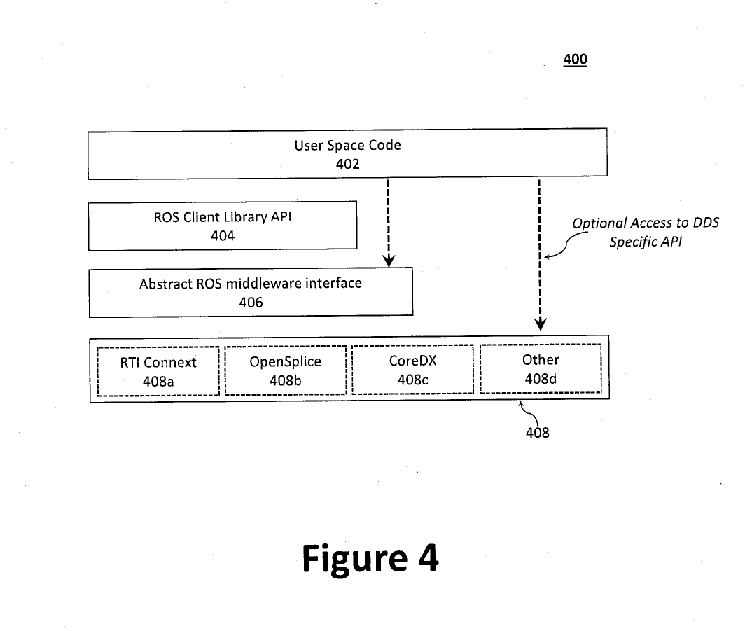

FIG. 4 illustrates an example abstraction approach 400 using ROS to transition to DDS transport layer 408. To preserve the look and feel of ROS, neither the ROS client library 404 nor the typical user need to directly access the DDS transport layer 408. Rather, user space code 402 can access the DDS transport layer 408 (e.g., RTI Connext 408a, OpenSplice 408b, CoreDX 408c, or other products 408d) through a ROS middleware interface 406 (e.g., an API specified as an interface). This arrangement also abstracts all information that is DDS-specific away from the user. As illustrated in FIG. 4, however, an optional direct access to the DDS transport layer 408 may be provided for certain users. The ROS middleware interface 406 may, however, be migrated to the DDS transport layer 408 in order to comply with security specifications.

Structures Subsystem Module 316.

The structures subsystem module 316 can be configured to model the primary structures (e.g., the fuselage 102, wing panels 106, etc.) of the aircraft and to use one or more multi-fidelity models to dynamically estimate the new strength of components as they degrade, which may then be used to calculate a new maximum load factor that the structure can safely withstand. The ability to rapidly assess instantaneous changes within the structure enables the autonomous aircraft health system 300 to respond in situ, adapting to the current structural capabilities of the condition-aware vehicle. In addition to reacting to changes within the structure, the system can establish the level of confidence for the impact of this change on the structural capability.

High-fidelity models capture the detailed response of the structure, yielding the highest level of confidence in the current state of the component. This high confidence allows the minimum reduction in structural capability, thus permitting the structural subsystem to operate with the maximum utility while maintaining safety. High-fidelity models, however, are computationally expensive and may require resources beyond those available onboard an aircraft. Low-fidelity models require minimal computational power, permitting the models to be run in situ and onboard an aircraft, and allow for rapid estimation of the current state of the subsystem. The confidence in the estimate is low, thereby requiring a larger capability reduction in order to ensure safe operation. Integrating multi-fidelity algorithms can maximize both aircraft safety and aircraft utility, rapidly responding to instantaneous subsystem degradations and updating subsystem capabilities as more detailed models update degraded capabilities.

An offline/online paradigm, however, may be used to provide the computational efficiency needed onboard the aircraft to map from the sensor data to capability state, thereby allowing the motion planner module 322 to act dynamically. A multi-fidelity approach is utilized by the structures subsystem module 316 to leverage a large set of physics-based simulations at a cost that allows computational feasibility onboard the aircraft. An offline stage employs high-fidelity structural analysis models to build up a damage library from the panel level through the aircraft level. These damage libraries are used to build surrogate models, which leverage the rich amount of physics-based information contained in the damage library while allowing rapid estimates of the structural state using onboard sensor measurements to support the dynamic decision-making of the condition-aware vehicle.

### Example

By way of illustration and without limitation, an example of a potential expansion of the methodology to additional airframe components and the influence of degradation of control surfaces on the radius of turn is presented. An objective is to relate the possible limitations on aircraft control surfaces (e.g., the aileron and rudder) due to structural degradation. These aircraft control surfaces are lifting surfaces, and therefore, load-bearing limits due to structural damage may reduce: (1) the maximum deflection of the control surfaces, and/or (2) the effectiveness of the control surface, which in turn is related to the values of some of the associated control derivatives. To quantify these phenomena, the following equation may be use for the steady-state values of sideslip angle β, rudder deflection δᵣ, and aileron deflection δₐ for a truly-banked level turn:

$$[ \begin{matrix}{C}_{{y}_{β}} & {C}_{{y}_{δ r}} & 0 \\ {C}_{{𝓁}_{β}} & {C}_{{𝓁}_{δ r}} & {C}_{{𝓁}_{δ a}} \\ {C}_{{n}_{β}} & {C}_{{n}_{δ r}} & {C}_{{n}_{δ a}}\end{matrix} ] [ \begin{matrix}β \\ δ r \\ δ a\end{matrix} ] = - [ \begin{matrix}{C}_{{y}_{r}} \\ {C}_{{𝓁}_{r}} \\ {C}_{{n}_{r }}\end{matrix} ] \frac{ω b cos φ}{2 V} ,$$

where ω is the angular rate of turn, ϕ is the roll angle, V is the airspeed (assumed constant), and b is the wingspan. Elements inside the matrices are the usual stability and control derivatives. Using the relations

$$tan φ = \frac{ω V}{g} , R = \frac{{V}^{2}}{g tan φ} ,$$

where R is the radius of turn, we can arrive at the following expression:

$$[ \begin{matrix}β \\ δ r \\ δ a\end{matrix} ] = - {E}^{- 1} [ \begin{matrix}{C}_{{y}_{r}} \\ {C}_{{𝓁}_{r}} \\ {C}_{{n}_{r}}\end{matrix} ] \frac{gb}{2 \sqrt{{V}^{4} + {g}^{2} {R}^{2}}} , \\ where E = [ \begin{matrix}{C}_{{y}_{β}} & {C}_{{y}_{δ r}} & 0 \\ {C}_{{𝓁}_{β}} & {C}_{{𝓁}_{δ r}} & {C}_{{𝓁}_{δ a}} \\ {C}_{{n}_{β}} & {C}_{{n}_{δ r}} & {C}_{{n}_{δ a}}\end{matrix} ] .$$

Define

$$C = [ \begin{matrix}{C}_{1} \\ {C}_{2} \\ {C}_{3}\end{matrix} ] = - {E}^{- 1} [ \begin{matrix}{C}_{{y}_{r}} \\ {C}_{{𝓁}_{r}} \\ {C}_{{n}_{r}}\end{matrix} ] .$$

Using the above equation, the following relationship between δₐ and R can be derived:

$$δ a = \frac{{C}_{3} gb}{2 \sqrt{{V}^{4} + {g}^{2} {R}^{2}}}$$

Propulsion PHM Module 318.

The propulsion subsystem module 318 estimates the health of various components in the propulsion system (e.g., the propulsors 104). For example, the propulsion subsystem module 318 may employ small perturbations in the engine state until they converge to a result that matches the sensor readings from the condition-aware aircraft 100. The propulsion subsystem module 318 is responsible for estimating the propulsion system performance and for determining if degradation is present in its major components. The propulsion health state estimator provides performance condition-awareness and low-fidelity physics-based model using thermodynamic cycle analysis, which is capable of executing onboard and in real time to model performance of various engine subsystems, thereby allowing for degradation of turbomachinery components and flow passages.

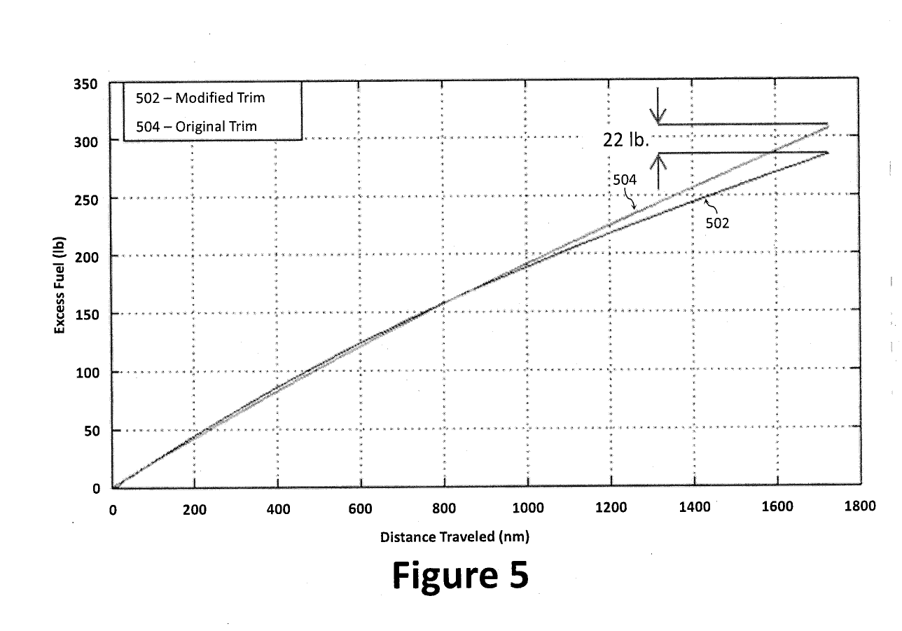

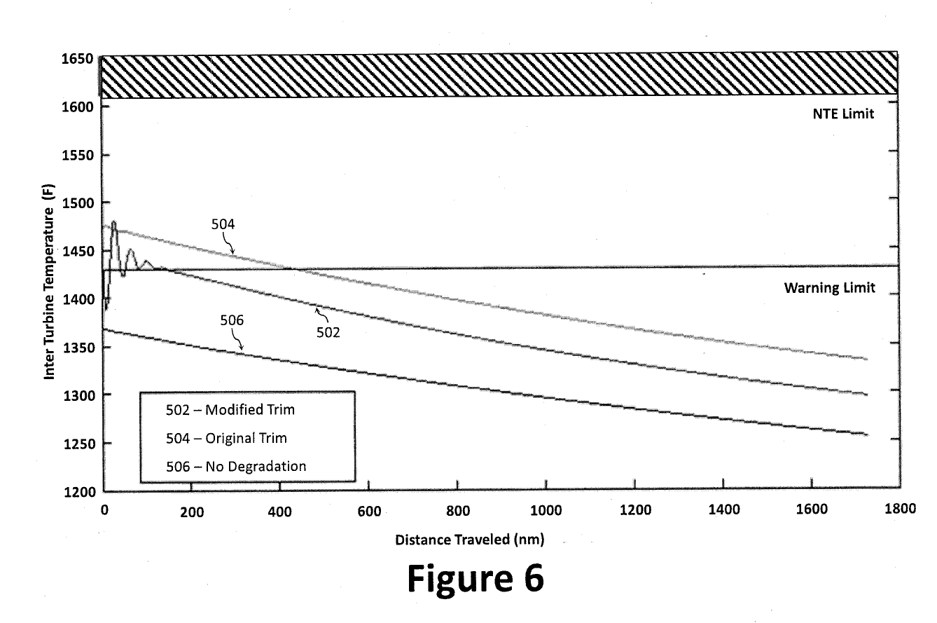

FIG. 5 illustrates fuel consumption savings of an aircraft with a degraded engine using the autonomous aircraft health system 300, while FIG. 6 illustrates an inlet turbine temperature of degraded engine. The simulation was modeled on an aircraft weighing 11,240 pounds, cruising at 60,000 feet, and 267 knots. The mission range was specified to be 1,728 nautical miles. The simulation included only the cruise portion of the mission and moderate fan degradation was induced at the beginning of the segment. A fan degradation factor of 0.94 was used, which is small enough to not trigger engine protection logic, but large enough to have impact on fuel consumption. Comparison of the excess fuel consumption over the cruise segment with the original trim state 504 and the modified trim state 502 calculated by the motion planner module 322 is shown in FIGS. 5 and 6. The modified trim state 502 at a slightly lower speed of 254.3 knots yielded 22 pounds of fuel savings, which is about 7.3% of the excess fuel consumption due to the engine degradation. Furthermore, the modified trim state 502 yields lower operating temperature, which decreases the probability of engine failure.

FIG. 7 illustrates an engine model schematic of a turbofan engine 700. As illustrated, the turbofan engine 700 generally comprises an inlet 702, a fan 704, a high pressure compressor (HPC) 706, a combustion chamber 708, a high pressure turbine (HPT) 710, a low pressure turbine (LPT) 712, a mixer 714, a nozzle 716, a bypass 718, and a core 720. While control inputs and sensor signals may be platform specific, the underlying operations of the autonomous aircraft health system 300 remain substantially the same for other types of propulsion systems, including piston engine systems and electric motor propulsion.

Degradation factors may be determined at each of the inlet 702, the fan 704, the HPC 706, the HPT 710, and the LPT 712. An array of PHM sensors 126 may be provided throughout the turbofan engine 700. For example, a plurality of sensors may be provided at the inlet 702 to measure the altitude (Alt), speed (MACH), ambient temperature (T_{AMB}), and ambient pressure (P_{AMB}). To measure temperature (T₁, T₂) and pressure (P₁, P₂) along the airflow path, temperature and pressure sensors may be provided (1) between the fan 704 and the HPC 706 and (2) between the HPC 706 and the combustion chamber 708. An additional temperature sensors may be provided between the HPT 710 and the LPT 712 to measure the interstage turbine temperature (ITT). Fan speed sensors may be provided at the fan 704 to measure a first fan speed (N_{L}) and at the HPT 710 to measure a second fan speed (N_{H}). Finally, a sensor may be provided to monitor fuel flow (W_{F}) to the combustion chamber 708.

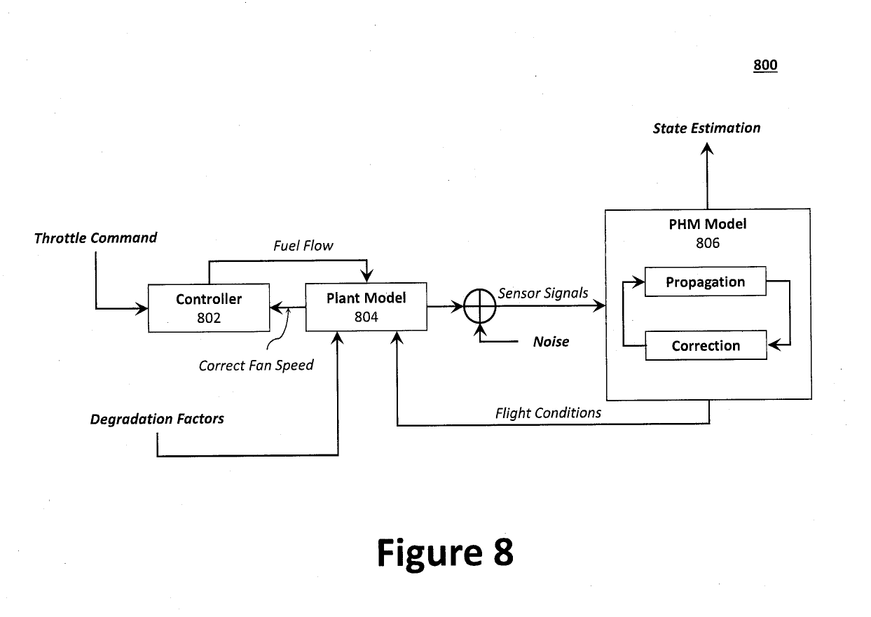

FIG. 8 illustrates a schematic of the propulsion health state estimator 800 of the propulsion PHM module 318. As illustrated, the propulsion health state estimator 800 comprises a controller 802, a plant model 804, and a PHM model 806. The propulsion subsystem module 318 receives, at the controller 802, inputs (e.g., throttle commands from the flight control system (FCS) 120), inputs regarding ambient conditions from the aircraft, as well as sensor signals from the propulsors 104. For example, fuel flow rate (WF) and ambient conditions can be used as control inputs to the PHM model 806, while the various sensors signals described in connection with FIG. 7 may be supplied as measurements.

The plant model 804 evaluates the thermodynamic and mechanical state of the system and calculates performance parameters including thrust and fuel consumption to, in effect, acts as a “digital twin” of the actual propulsion system. The plant model 804 compares the calculated performance to available sensor signals in order to estimate the health state of major propulsion system components. The outputs of the plant model 804 may also be used by the motion planner module 322 to compute flight path and maneuver capabilities. For the turbofan engine, for example, the plant model 804 may be based on the Brayton cycle analysis for a two-spool turbofan engine. Fan, compressor, and turbine performance can be modeled using turbomachinery maps. The health state of the turbomachinery components can be modeled using degradation factors for their adiabatic efficiency and the health state of the engine inlet can be modeled using a degradation factor for the inlet pressure recovery.

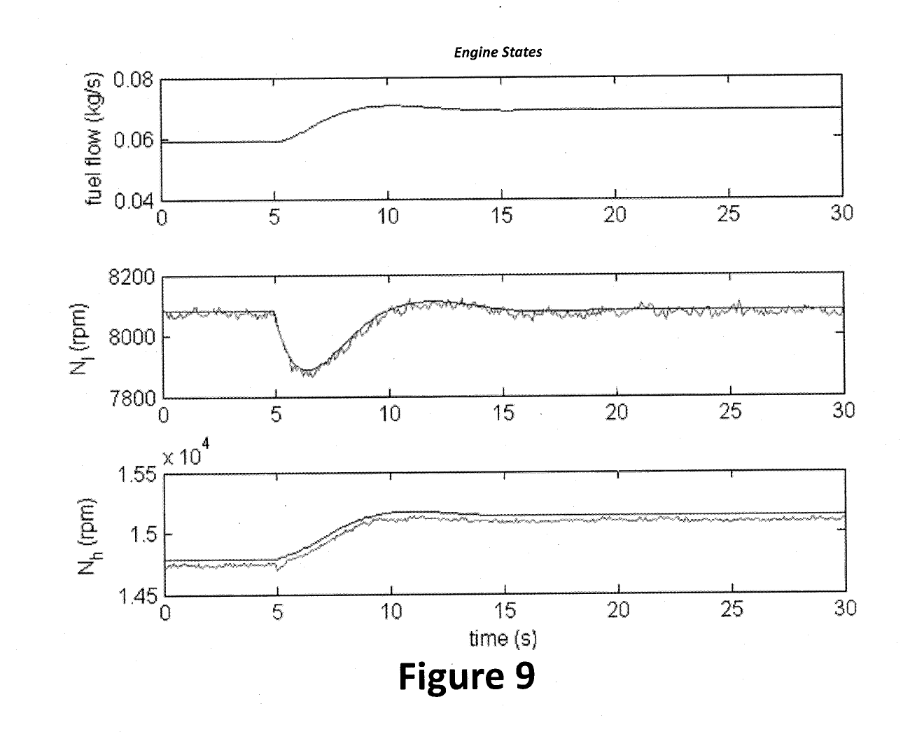

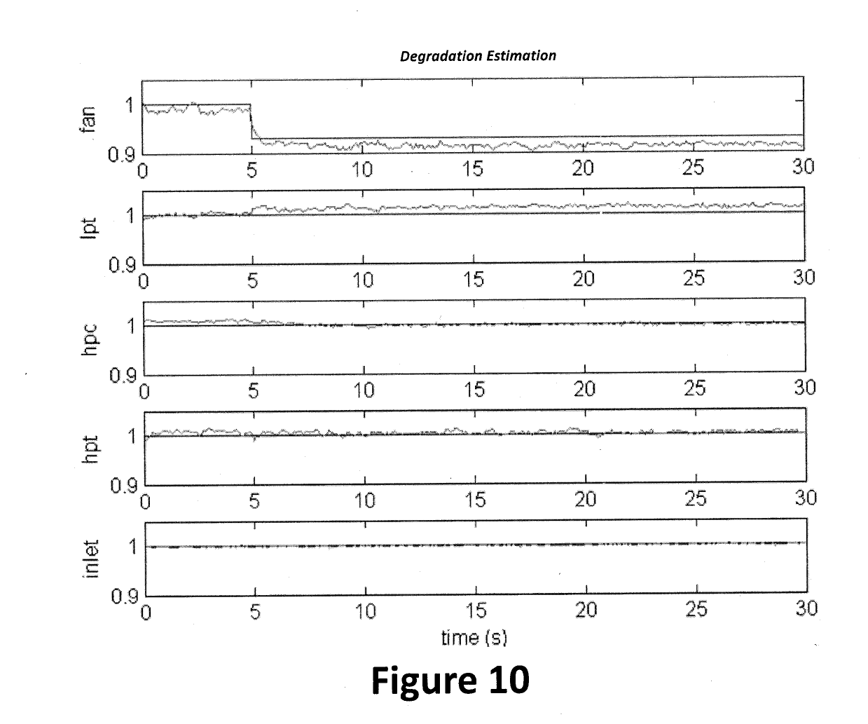

The PHM model 806 may be used to estimate health state and remaining useful life, which may be based on the extended Kalman filter (EKF) theory. The PHM model 806 may employ propagation and correction techniques. For example, the evaluation of the system Jacobians may be performed by the PHM model 806 using the small perturbations approach, where the model is incremented with a small delta around its nominal state and a central difference scheme is used to numerically obtain partial derivatives. The PHM model 806 estimates degradation factors by comparing sensor signals (e.g., from the PHM sensors 126) to model predictions, where the engine states are represented by the two spool speeds, further augmented with the five degradation factors. Once the degradation factors are properly estimated, the degraded thrust and fuel consumption can be obtained from the engine model. FIGS. 9a and 9b illustrate, respectively, example engine state measurements (e.g., N_{H}, N_{L}, and W_{F}) and degradation estimations (e.g., inlet, HPT, HPC, LPT, and fan).

In addition to the health estimator, the propulsion PHM module features a prognostics capability to determine the remaining useful life of major engine components. The RUL estimation can be achieved using the life extension analysis and prognostics-frog (LEAP) algorithm, which is a prognostic statistical approach for characterizing and predicting RUL of a system. The LEAP-Frog approach uses regression to resolve the issue of using a large data set to track overall data trends and using a smaller set of data to rapidly respond to enhanced degradation as the component/system begins to develop health issues. The first step in the LEAP-Frog algorithm is to build a linear regression model using the previous degradation estimates generated by the EKF algorithm and then predict the degradation at the current time. The degradation predicted by the LEAP-Frog algorithm at the current time is then compared to the degradation provided by the EKF algorithm at that time. If the current health state estimate is within three standard deviations of the LEAP-Frog predicted degradation then the degradation model generated using the linear regression is assumed valid. If not then the number of previous estimated degradation points (allowable window) used for building the linear regression model is reduced and the process is started all over again. The lengths of allowable windows are predefined and are user specified before the data is processed. The RUL predictions for the engine components as well as degraded thrust and fuel consumption estimate are communicated to the motion planner module 322, so that the propulsion system health state can be taken into consideration when planning/re-planning a mission.

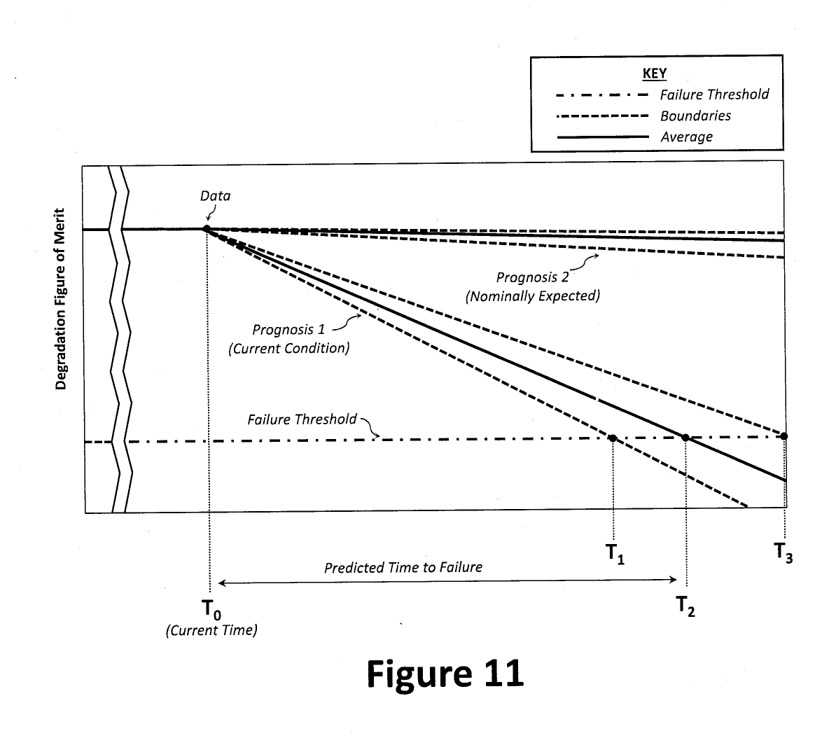

FIG. 11 illustrates a graph of prognoses based on current aircraft condition (prognosis 1) vis-à-vis a nominally expected prognosis (prognosis 2). As illustrated, the time to failure can be estimated with linear regression to predict long-term degradation as function of the current time (T₀). As illustrated, the prognosis based on current aircraft condition predicts that the aircraft is degrading prematurely, with an expected time of failure between times T₁ and T₃, where the estimated time of failure is T₂. Thus, the Predicted Time to Failure is the time between T₀ and T₂. If the error between linear regression and PHM degradation estimates is larger than 3 standard deviations, a smaller subset of degradation data may be used to redefine the linear regression trend. The RUL data can be used by motion planner module 322, as well as for maintenance and repair scheduling.

Motion planner module 322.

The motion planner module 322 allows for fast incremental replanning and/or low-level control adjustment to optimize mission performance. A requirement of a route-planning algorithm is that the resultant route (sequence of waypoints) be compatible with the aircraft's physical capabilities, such as its minimum turn radius under safe airframe loading limits.

The motion planner module's 322 route-planning system may be based on H-cost motion-planning techniques, which may be applied to incorporate constraints due to vehicle dynamical behavior into a geometric path-planning algorithm based on workspace cell decomposition. In other words, vehicle dynamical constraints can be mapped to successions of edges in the cell decomposition graph, which is searched for route-planning. To ensure that the sequence of waypoints can be navigated by the trajectory planner, a discrete mathematical model, called the lifted graph, can be embedded with information about aircraft capabilities that affect its maneuverability, which may be derived from data provided by the PHM modules 314 (e.g., the structures subsystem module 316 and propulsion subsystem module 318). The data can be analyzed by the aircraft processor 116 to determine state- and input-constraints and capability envelopes (e.g., maximum allowable G-forces, maximum thrust, etc.). This analysis may be used to decouple the proposed route-planning system from the internal details of the PHM algorithms, thereby paving the way for a highly portable and platform-independent autonomous aircraft health system 300.

In order to facilitate the interface between the human operator and motion planner, the system may be capable of accepting high-level mission requirements in a format similar to natural language. To achieve this, the route-planning system may generate a plan that satisfies specifications given in linear temporal logic (LTL).

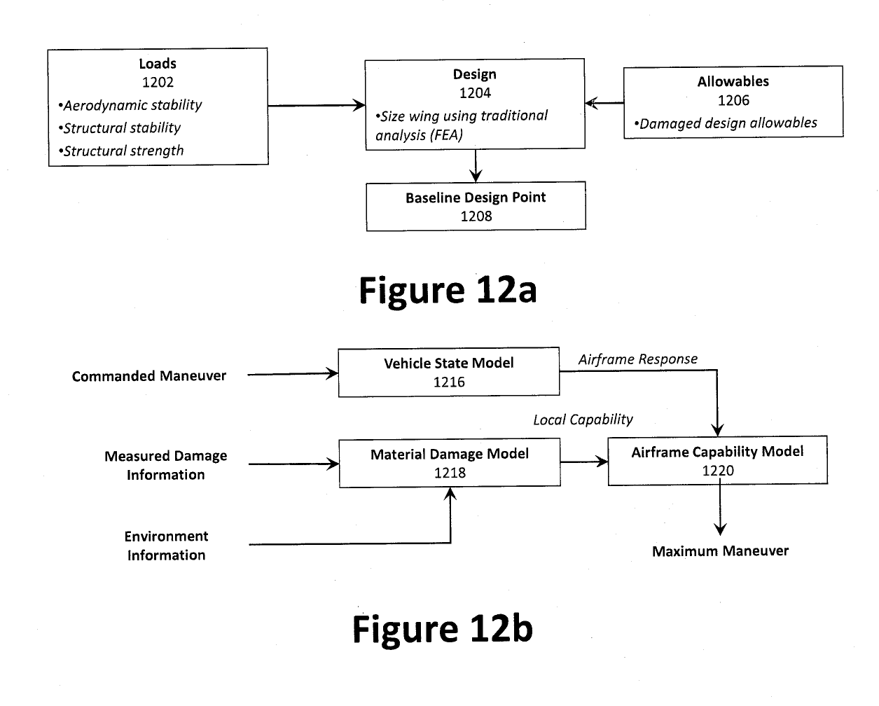

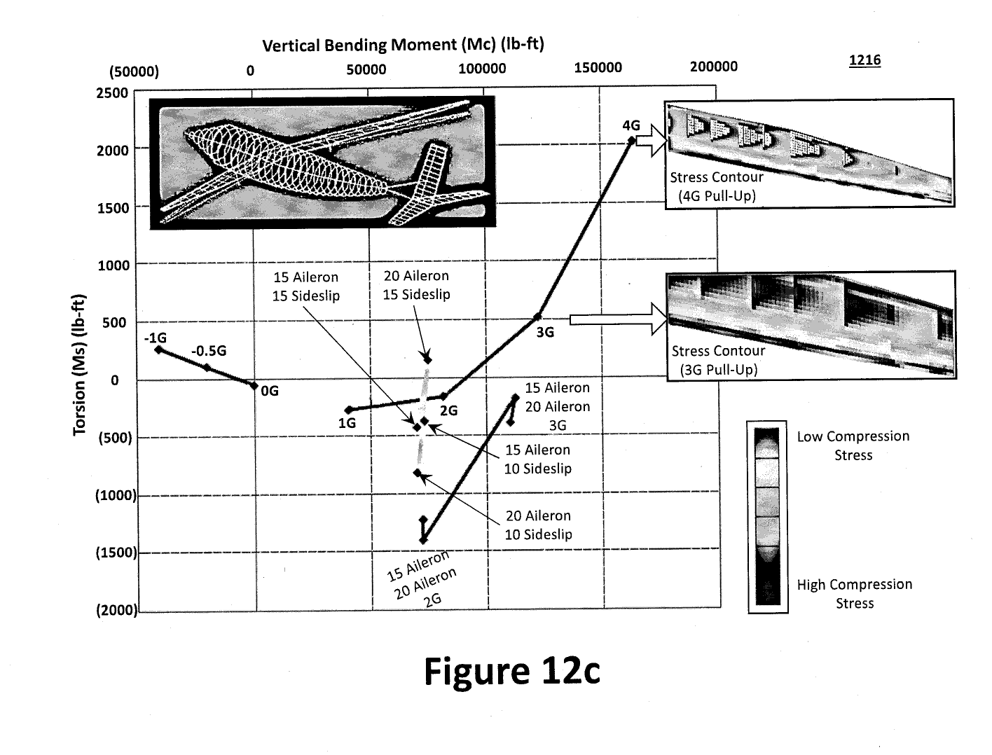

FIGS. 12a and 12b illustrate subsystems of the structures subsystem module 316 that facilitate design and safety-assured maneuvering. With reference to FIG. 12a, design system 1204 may size the wing using traditional analysis (e.g., FEA) using load data 1202 and allowables data 1206 to generate the baseline design point 1208. The load data 1202 may include, for example, aerodynamic stability, structural stability, and structural strength. The allowables data 1206 may dictate damaged design allowables. The maximum maneuver may be determined as illustrated in FIG. 12b as a function of the commanded maneuver (e.g., from the VMS 134), damage information (e.g., from the PHM sensors 126), and environment data (e.g., from the ISR Payload 110), such as temperature. The commanded maneuver serves as an input to the vehicle state model 1216, while the damage information and the environment data serve as inputs to the material damage model 1218. The vehicle state model 1216 translates the commanded maneuver 1210 into airframe structural responses, an example of which is illustrated in FIG. 12c. For example, based on the commanded maneuver, the aircraft processor 116 may generate data to prepare a heat map of the stress on the airframe at different G-forces acting on the airframe.

The material damage model 1218 may be used to determine a local capability of the aircraft based on state. For example, the material damage model 1218 may employ the Open-hole Damage Model to track the damage progression of open-hole composite laminates under compressive loading via, for example, the two stress fracture criteria proposed by Whitney and Nuismer (known as the point stress criterion and the average stress criterion). The stress distribution around an open-hole may be assessed via the following equation:

$${σ}_{y} ( x , 0 ) = \frac{{σ}^{∞}}{2} \{ 2 + {( \frac{r}{x} )}^{2} + 3 {( \frac{r}{x} )}^{4} - ( {K}_{T}^{∞} - 3 ) [ 5 {( \frac{r}{x} )}^{6} - {y ( \frac{r}{x} )}^{8} ] \} ,$$

while the notched strength ratio may be assessed via the following equation:

$$\frac{{σ}_{N}}{{σ}_{0}} = \frac{2 ( 1 - {ξ}_{1} )}{2 - {ξ}_{1}^{2} - {ξ}_{1}^{4} + ( {K}_{T}^{∞} - 3 ) ( {ξ}_{1}^{6} - {ξ}_{1}^{8} )} .$$

The design allowables may include a baseline design based on an open-hole compression (OHC) strength with a peak condition of an unnotched compression strength. The airframe compatibility model 1220 generates the maximum maneuver for the aircraft based on its current state based on at least in part on the outputs from the vehicle state model 1216 and the material damage model 1218.

The integration of the various components of the autonomous aircraft health system 300 was tested using a simplified UAV dynamics model incorporating the degraded condition of the engine. The states are position coordinates, x, y, z, airspeed, v, heading angle, ψ, and flight path angle, γ. The inputs are angle of attack, α, roll angle, ϕ, (direction in yz plane of the lift vector), and engine fuel flow rate, σ. The thrust, T, is assumed a known function of engine fuel flow rate, σ, and the airspeed, v. The lift produced is L=½ρv²SC_{Lα}α, and the drag is D=½ρv²S(C_{D0}+KC_{Lα}²α²). The equations of motion are as follows:

$$\dot{x} ( t ) = v ( t ) cos η ( t ) cos ψ ( t )$$

$$\dot{y} ( t ) = v ( t ) cos γ ( t ) sin ψ ( t )$$

$$\dot{z} = - v ( t ) sin γ ( t )$$

$$\dot{v} ( t ) = \frac{T ( σ ( t ) , v ( t ) ) - D ( v ( t ) , α ( t ) ) - mg sin γ ( t )}{m}$$

$$\dot{γ} ( t ) = \frac{L ( v ( t ) , α ( t ) ) cos φ ( t ) - mg cos γ ( t )}{mv ( t )}$$

$$\dot{ψ} ( t ) = \frac{- L ( v ( t ) , α ( t ) ) sin φ ( t )}{mv cos γ ( t )}$$

The independent variable was changed from time, t, to the length parameter, s, where v(t)=ds/dt(t). The objective is to track the same geometric trajectory with a different speed profile.

Note:

$$\frac{d ( \cdot )}{ds} = \frac{d ( \cdot )}{dt} \frac{dt}{ds} = \frac{1}{v} \frac{d ( \cdot )}{dt}$$

Denote:

$$\frac{d ( \cdot )}{ds} ≡ {( \cdot )}^{′} . \\ {x}^{′} ( s ) = cos γ ( s ) cos ψ ( s )$$

$${y}^{′} ( s ) = cos γ ( s ) sin ψ ( s )$$

$${z}^{′} = - sin γ ( s )$$

$${v}^{′} ( s ) := {f}_{v} ( v , σ , α , φ ) = \frac{T ( σ ( s ) , v ( s ) ) - D ( v ( s ) , α ( s ) ) - mg sin γ ( s )}{mv ( s )}$$

$$\dot{γ} ( s ) := {f}_{γ} ( v , σ , α , φ ) = \frac{L ( v ( s ) , α ( s ) ) cos φ ( s ) - mg cos γ ( s )}{{mv}^{2} ( t )}$$

$$\dot{ψ} ( s ) := {f}_{ψ} ( v , σ , α , φ ) = \frac{- L ( v ( s ) , α ( s ) ) sin ψ ( s )}{{mv}^{2} ( s ) cos γ ( s )}$$

Denote Tₚ(σ(s),v(s)) and T_{d}(σ(s),v(s)), respectively, the thrust generated by the pristine and degraded engines. Denote (xᵣ, yᵣ, zᵣ, vᵣ, γᵣ, ψᵣ) the reference state trajectory, and (σᵣ,αᵣ,ϕᵣ) the reference inputs. Small variations must be identified from the reference values: (Δv, Δσ,Δα, and Δϕ) to respond to the degraded engine.

In the pristine state,

fᵥ_{ₚ}(vᵣ,σᵣ,αᵣ,ϕᵣ)=f_{γ}(vᵣ,σᵣ,αᵣ,ϕᵣ)=f_{ψ}(vᵣ,σᵣ,αᵣ,ϕᵣ)=0

With the engine in degraded condition, the following equations must be satisfied:

fᵥ_{ₚ}(vᵣ+Δv,σᵣ+Δσ,αᵣ+Δα,ϕᵣ+Δϕ)=0,

f_{γ}(vᵣ+Δv,σᵣ+Δσ,αᵣ+Δα,ϕᵣ+Δϕ)=0,

f_{ψ}(vᵣ+Δv,σᵣ+Δσ,αᵣ+Δα,ϕᵣ+Δϕ)=0.

Using first-order approximations:

$$\begin{matrix}{f}_{{v}_{d}} ( {v}_{r} , {σ}_{r} , {α}_{r} , {φ}_{r} ) + \frac{\partial {f}_{{v}_{d}}}{\partial v} {\vert}_{r} Δ v + \frac{\partial {f}_{{v}_{d}}}{\partial σ} {\vert}_{r} Δ σ + \frac{\partial {f}_{{v}_{d}}}{\partial α} {{\vert}_{r} Δ α + \frac{\partial {f}_{{v}_{d}}}{\partial φ} \vert}_{r} Δ φ = 0 , & ( 1 ) \\ {{{{ \frac{\partial {f}_{γ}}{\partial v} \vert}_{r} Δ v + \frac{\partial {f}_{γ}}{\partial σ} \vert}_{r} Δ σ + \frac{\partial {f}_{γ}}{\partial α} \vert}_{r} Δα + \frac{\partial {f}_{γ}}{\partial φ} \vert}_{r} Δ φ = 0 , & ( 2 ) \\ {{{{ \frac{\partial {f}_{ψ}}{\partial v} \vert}_{r} Δ v + \frac{\partial {f}_{ψ}}{\partial σ} \vert}_{r} Δ σ + \frac{\partial {f}_{ψ}}{\partial α} \vert}_{r} Δ α + \frac{\partial {f}_{ψ}}{\partial φ} \vert}_{r} Δ φ = 0 , & ( 3 )\end{matrix}$$

Note:

$$\begin{matrix}{f}_{{v}_{d}} ( {v}_{r} , {σ}_{r} , {α}_{r} , {φ}_{r} ) = \frac{{T}_{d} ( {σ}_{r} , {v}_{r} ) - D ( {v}_{r} , {α}_{r} ) - mg sin {γ}_{r}}{{mv}_{r}} \\ = \frac{{T}_{p} ( {σ}_{r} , {v}_{r} ) - D ( {v}_{r} , {α}_{r} ) - mg sin {γ}_{r}}{{mv}_{r}} - \\ \frac{{T}_{p} ( {σ}_{r} , {v}_{r} ) - {T}_{d} ( {σ}_{r} , {v}_{r} )}{{mv}_{r}} \\ = \frac{{T}_{d} ( {σ}_{r} , {v}_{r} ) - {T}_{p} ( {σ}_{r} , {v}_{r} )}{{mv}_{r}}\end{matrix}$$

The term T_{d}(σᵣ,vᵣ)−Tₚ(σᵣ,vᵣ) is the difference between the thrust produced by the degraded and pristine engines at the reference fuel flow rate and airspeed. The various derivatives are as follows:

$$\frac{\partial {f}_{v}}{\partial v} = - \frac{{f}_{v}}{v} + \frac{1}{mv} ( \frac{\partial T}{\partial v} - ρ v {SC}_{D} ) , \frac{\partial {f}_{v}}{\partial σ} = \frac{1}{mv} \frac{\partial T}{\partial σ} , \\ \frac{\partial {f}_{v}}{\partial α} = - \frac{ρ v {SKC}_{L \_ α}^{2} α}{m} , \frac{\partial {f}_{v}}{\partial φ} = 0 , \\ \frac{\partial {f}_{γ}}{\partial v} = 2 \frac{g cos γ}{{v}^{3}} , \frac{\partial {f}_{y}}{\partial σ} = 0 , \\ \frac{\partial {f}_{γ}}{\partial α} = \frac{1}{2} \frac{ρ {SC}_{{L}_{α}} cos φ}{m} , \frac{\partial {f}_{y}}{\partial φ} = - \frac{1}{2} \frac{ρ {SC}_{{L}_{α}} α cos φ}{m} , \\ \frac{\partial {f}_{ψ}}{\partial v} = 0 , \frac{\partial {f}_{ψ}}{\partial σ } = 0 , \\ \frac{\partial {f}_{ψ}}{\partial α} = - \frac{1}{2} \frac{ρ {SC}_{{L}_{α}} sin φ}{m cos γ} , \frac{\partial {f}_{ψ}}{\partial φ} = - \frac{1}{2} \frac{ρ {SC}_{{L}_{α}} α cos φ }{m cos γ}$$

First-order equations (1)-(3) are a system of three equations in four unknowns, namely, Δv, Δσ, Δα, and Δϕ. The equation can be reduced to three equations with three unknowns by considering only longitudinal stability.

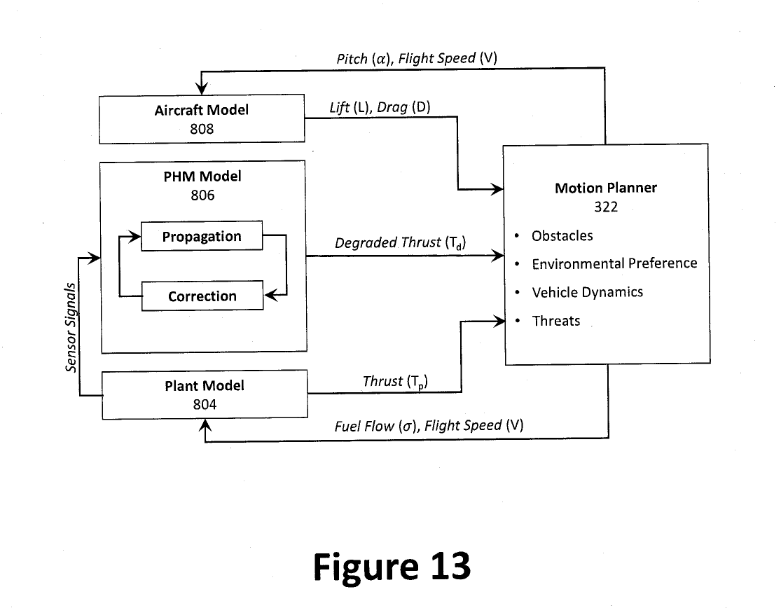

The methodology presented above enables the estimation of the aircraft trim state, determined by flight speed (V), fuel command (a), and angle of attack (a), such that the excess fuel consumption with a degraded engine is minimized. Examining the equations of motion with linear approximations around the trim condition enables the estimation of small control adjustments (ΔV, Δσ, Δα) needed to minimize fuel consumption. This requires knowledge of the engine thrust in both pristine and degraded states as functions of flight speed and fuel flow rate, as well as the partial derivatives. These functions can be obtained using the plant model 804. The thrust derivatives can be evaluated numerically using central difference scheme. Additional inputs required by the motion planner module 322 include lift and drag provided by an aircraft model 808. A schematic of the system architecture for the motion planner module 322 is shown in FIG. 13.

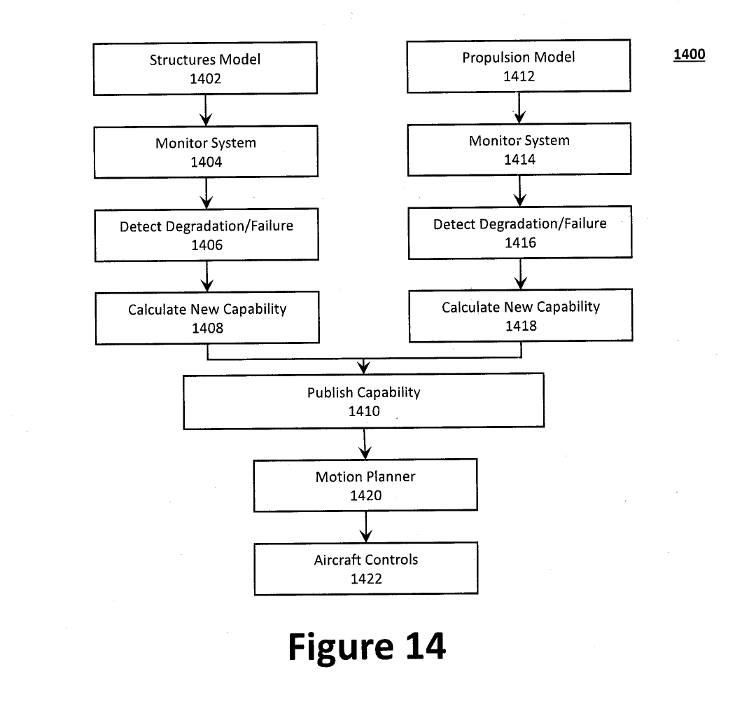

FIG. 14 illustrates an example method 1400 for providing adjustments to flight maneuvers. As illustrated, a model of the structure is generated at 1402. The aircraft is monitored during operation for degradation to the structure at step 1404. If degradation to the structure is detected at step 1404, a new structure capability is calculated for the aircraft based on its current condition of the structure at step 1408. Similarly, a model of the propulsion system is generated at 1412. The aircraft is monitored for degradation to the propulsion system during operation at step 1414. If degradation to the propulsion system is detected at step 1414, a new propulsion capability is calculated for the aircraft based on its current condition of the propulsion system at step 1408. At step 1410, the new structure capability and the new propulsion capability are published to the data bus 302 via, respectively, the structures subsystem module 316 and the propulsion subsystem module 318. The motion planner module 322 then prepare updated flight commands based at least in part on the new structure capability and the new propulsion capability at step 1420. At step 1422, the motion planner module 322 communicates the modified flight commands to the flight control system 120.

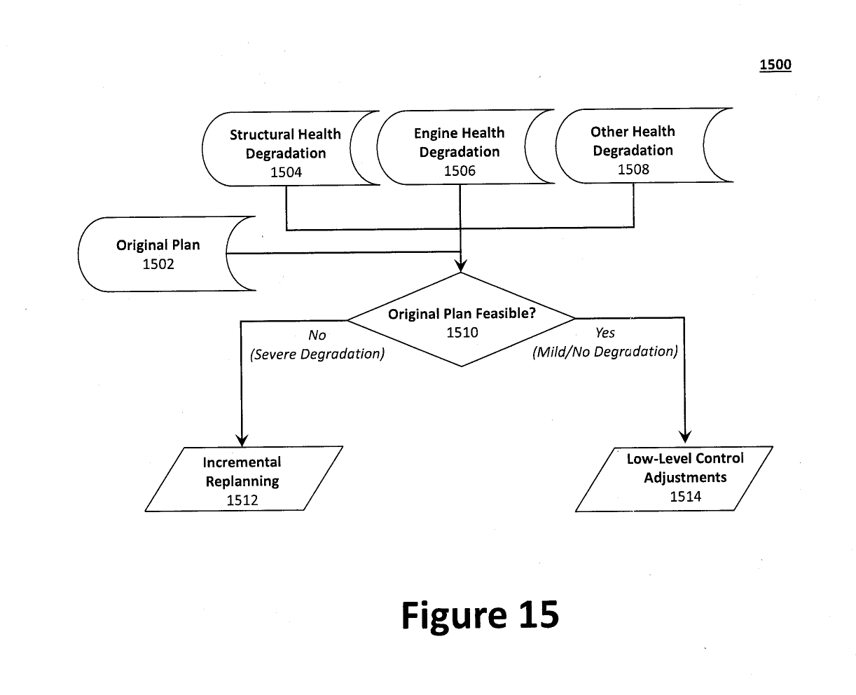

FIG. 15 illustrates an example implementation 1500 of the autonomous aircraft health system framework. As illustrated, the autonomous aircraft health system framework receives as data inputs: the original flight plan data 1502 (e.g., from the flight control system 120); structural health degradation information 1504 (e.g., from the structures subsystem module 316); engine health degradation information 1506 (e.g., from the propulsion subsystem module 318); and any other health degradation information 1508 (e.g., from the one or more other subsystem modules 320).

Based on the health degradation information, the autonomous aircraft health system determines at step 1510 whether the original flight plan dictated by the original flight plan data 1502 is still feasible. If severe degradation is determined, the autonomous aircraft health system determines that the original flight plan is not feasible and incremental replanning (e.g., a fast incremental replanning algorithm) may be implemented at step 1512. If the no degradation or mild degradation (i.e., less than a predetermined degradation threshold) is determined, the autonomous aircraft health system determines that the original flight plan is feasible and low-level control adjustments are implemented at step 1514 in the presence of degradation.

An objective of the level control adjustments is to identify small control adjustments (e.g., ΔV, Δσ, Δα) to minimize excess fuel consumption. Using linear approximations around the original trim conditions, the equations of motion for the degraded system can be written as:

$$\begin{matrix}{f}_{{v}_{d}} ( {v}_{r} , {σ}_{r} , {α}_{r} , {φ}_{r} ) + \frac{\partial {f}_{{v}_{d}}}{\partial v} {\vert}_{r} Δ v + \frac{\partial {f}_{{v}_{d}}}{\partial σ} {\vert}_{r} Δ σ + \frac{\partial {f}_{{v}_{d}}}{\partial α} {{\vert}_{r} Δ α + \frac{\partial {f}_{{v}_{d}}}{\partial φ} \vert}_{r} Δ φ = 0 , \\ {{{{ \frac{\partial {f}_{γ}}{\partial v} \vert}_{r} Δ v + \frac{\partial {f}_{γ}}{\partial σ} \vert}_{r} Δ σ + \frac{\partial {f}_{γ}}{\partial α} \vert}_{r} Δα + \frac{\partial {f}_{γ}}{\partial φ} \vert}_{r} Δ φ = 0 , \\ {{{{ \frac{\partial {f}_{ψ}}{\partial v} \vert}_{r} Δ v + \frac{\partial {f}_{ψ}}{\partial σ} \vert}_{r} Δ σ + \frac{\partial {f}_{ψ}}{\partial α} \vert}_{r} Δ α + \frac{\partial {f}_{ψ}}{\partial φ} \vert}_{r} Δ φ = 0.\end{matrix}$$

Where vᵣ denotes the airspeed, σᵣ denotes the fuel flow rate, αᵣ denotes the angle of attack, ϕᵣ denotes the roll angle, r denotes trim states, and d denotes degraded states.

Evaluating the partial derivatives requires knowledge of (1) aerodynamic capability (vehicle state model) and (2) thrust as a function of fuel flow and air speed in both pristine (engine model) and degraded state (health estimator), and partial derivatives at the reference trim state. Solving the equations of motion for the degraded system also requires a cost function of the form:

J(Δv,Δσ):=½(r₁Δv²=r₂Δσ²),

first-order necessary condition for optimality yields:

r₁Δv+r₂Δσ=0.

While the forgoing has been described in relation to aircraft and spacecraft, the forgoing teachings may be similarly applied to other vehicles, including land vehicles (e.g., cars, trucks, trains, etc.) and water vehicles (e.g., boats, ships, submarines, etc.). The above-cited patents and patent publications are hereby incorporated by reference in their entirety. Although various embodiments have been described with reference to a particular arrangement of parts, features, and like, these are not intended to exhaust all possible arrangements or features, and indeed many other embodiments, modifications, and variations may be ascertainable to those of skill in the art. Thus, it is to be understood that the disclosure may therefore be practiced otherwise than as specifically described above.

What is claimed is:

1. A health monitoring system for an aircraft having a flight control system, a primary structure, and a propulsion system, the monitoring system comprising:
a plurality of sensors configured to monitor dynamically one or more parameters of the primary structure and the propulsion system; and
a processor operatively coupled with the flight control system, the plurality of sensors, and a memory device, wherein the processor is configured to:
generate, via the processor, a structural model of the primary structure based at least in part on the one or more parameters, wherein the structural model reflects a dynamic structural integrity of the primary structure;
generate, via the processor, a propulsor model of the propulsion system based at least in part on the one or more parameters, wherein the propulsor model reflects a dynamic performance condition of the propulsion system;
compute flight path and maneuver capabilities for the self-aware aircraft based at least in part on the dynamic structural integrity of the primary structure and the dynamic performance condition of the propulsion system;
generate flight commands based at least in part on the flight path and maneuver capabilities; and
communicate the flight commands to the flight control system.

2. The health monitoring system of claim 1, wherein the plurality of sensors are configured to measure at least a thermodynamic parameter of the propulsion system and a mechanical parameter of the primary structure.

3. The health monitoring system of claim 2, wherein the plurality of sensors comprises at least one of a strain sensor or an electrical resistance sensor embedded in the primary structure.

4. The health monitoring system of claim 3, wherein the plurality of sensors comprises at least one of a temperature sensor or a pressure sensor integrated with the propulsion system.

5. The health monitoring system of claim 1, wherein at least one of the plurality of sensors is configured to communicate wirelessly with the processor via a wireless transmitter or a wireless transceiver.

6. The health monitoring system of claim 1, wherein the processor is configured to generate updated flight commands dynamically in response to structural changes detected within the primary structure by one or more of the plurality of sensors.

7. The health monitoring system of claim 1, wherein the processor is configured to compare a calculated performance for a propulsion system component to available sensor signals in order to estimate the health state of the propulsion system component.

8. The health monitoring system of claim 1, wherein the processor is configured, via the propulsor model, to estimate a health state or a remaining useful life of the propulsion system based at least in part on an extended Kalman filter (EKF) theory.

9. A self-aware aircraft comprising:
a primary structure;
a propulsion system;
a flight control system;
a plurality of sensors configured to monitor dynamically one or more parameters of the primary structure and the propulsion system;
a processor operatively coupled with the flight control system, the plurality of sensors, and a memory device;
a structures subsystem module configured to generate a structural model of the primary structure based at least in part on the one or more parameters, wherein the structural model reflects a dynamic structural integrity of the primary structure;
a propulsion subsystem module configured to generate a propulsor model of the propulsion system based at least in part on the one or more parameters, wherein the propulsor model reflects a dynamic performance condition of the propulsion system; and
a motion planner module configured to generate, via the processor, flight commands during operation of the self-aware aircraft based at least in part on the dynamic structural integrity and the dynamic performance condition.

10. The self-aware aircraft of claim 9, wherein the primary structure comprises a composite material and the at least one of the plurality of sensors is embedded in the composite material.

11. The self-aware aircraft of claim 9, wherein the plurality of sensors comprises at least one of a strain sensor or an electrical resistance sensor embedded in the primary structure.

12. The self-aware aircraft of claim 9, wherein the plurality of sensors comprises at least one of a temperature sensor or a pressure sensor integrated with the propulsion system.

13. The self-aware aircraft of claim 9, wherein the structures subsystem module, propulsion subsystem module, and motion planner module are communicatively coupled to one another and to the flight control system via a data bus.

14. The self-aware aircraft of claim 9, wherein the data bus is a Data Distribution Service (DDS) open standard data bus.

15. The self-aware aircraft of claim 9, wherein the data bus is operatively coupled with the plurality of sensors via one or more abstraction layers.

16. The self-aware aircraft of claim 9, wherein at least one of the plurality of sensors is configured to monitor a surrounding environment of the self-aware aircraft and the motion planner module generated the flight commands to account for surrounding environment.

17. The self-aware aircraft of claim 9, wherein the processor is configured to provide in situ feedback to a remotely situated maintenance unit to coordinate maintenance of the self-aware aircraft.

18. A method of navigating a self-aware aircraft having a flight control system, a primary structure, and a propulsion system, the method comprising the steps of:
monitoring via one or more sensors operatively coupled with a processor, one or more parameters of the primary structure and the propulsion system during operation;
generating, via the processor, a structural model of the primary structure based at least in part on the one or more parameters, wherein the structural model reflects a dynamic structural integrity of the primary structure;
generating, via the processor, a propulsor model of the propulsion system based at least in part on the one or more parameters, wherein the propulsor model reflects a dynamic performance condition of the propulsion system;
computing flight path and maneuver capabilities for the self-aware aircraft based at least in part on the dynamic structural integrity of the primary structure and the dynamic performance condition of the propulsion system;
generating flight commands based at least in part on the flight path and maneuver capabilities; and
communicating the flight commands to the flight control system.

19. The method of claim 18, further comprising the step of monitoring a surrounding environment of the self-aware aircraft, wherein the flight commands account for surrounding environment.

20. The method of claim 18, further comprising the step of providing in situ feedback to a remotely situated maintenance unit to coordinate maintenance of the self-aware aircraft.

21. The method of claim 18, wherein the flight control commands comprise at least a pitch command and a flight speed command.
